(19) United States
(12) Patent Application Publication
(10) Pub. No.: US 2025/0167205 A1
(43) Pub. Date: May 22, 2025

(54) NEGATIVE ELECTRODE ACTIVE MATERIAL, METHOD FOR PRODUCING THE SAME AND SECONDARY BATTERY INCLUDING THE SAME

(71) Applicant: LEMON ENERGY Inc., Incheon (KR)

(72) Inventors: Si Hyun LEE, Incheon (KR); Jin Suk LEE, Incheon (KR); Yu Jeong AHN, Incheon (KR); Seong In HWANG, Incheon (KR)

(73) Assignee: LEMON ENERGY Inc., Incheon (KR)

(21) Appl. No.: 18/950,218

(22) Filed: Nov. 18, 2024

(30) Foreign Application Priority Data
Nov. 20, 2023 (KR) 10-2023-0160195
Jun. 24, 2024 (KR) 10-2024-0081840

(51) Int. Cl. H01M 4/133; H01M 4/02; H01M 4/04; H01M 4/1393; H01M 4/62; H01M 4/86

(52) U.S. Cl. CPC H01M 4/133; H01M 4/0471; H01M 4/1393; H01M 4/625; H01M 4/8657; H01M 2004/021; H01M 2004/027

(57) ABSTRACT

The present disclosure relates to a negative electrode active material, a method for producing the same, and a secondary battery including the same. In one embodiment, the negative electrode active material includes: a first hollow core having a first hollow portion formed therein; and at least one composite particle packed in the first hollow portion, wherein the composite particle includes a graphite core, and a graphene layer and a first coating layer sequentially formed on the outer surface of the graphite core, wherein the first coating layer includes a hard coating layer, and the first coating layer and the first hollow core each have a higher hardness than the graphite core and the graphene layer.

### CROSS-REFERENCE TO RELATED APPLICATION

This application claims priority from and the benefit of Korean Patent Application No. 10-2023-0160195, filed on Nov. 20, 2023 and No. 10-2024-0081840, filed on Jun. 24, 2024, which is hereby incorporated by reference for all purposes as if set forth herein.

### BACKGROUND

### Field

The present disclosure relates to a negative electrode active material, a method for producing the same, and a secondary battery including the same.

### Discussion of the Background

Currently, problems associated with fossil fuel use that leads to the generation of greenhouse gases such as carbon dioxide and rising global temperatures are serious. Regulations on carbon dioxide emissions have become stricter in countries around the world, and the introduction of electric vehicles that use electricity as a power source has increased rapidly to replace internal combustion engine vehicles that use fossil fuels as a power source for engines.

Secondary batteries, which are used to supply electricity to electric vehicles, are a key component of electric vehicles that can be reused repeatedly through charging, unlike primary batteries that are discarded once used. In addition, secondary batteries are used in various applications, including electric vehicles, laptop PCs, mobile devices, vertical take-off and landing aircrafts for urban air mobility (UAM), and electricity storage systems. Recently, with the development of industry, the demand for high-capacity, low-weight, and high-efficiency secondary batteries has increased, and research thereon has been actively conducted.

Representative secondary batteries include lead-acid batteries, nickel-cadmium batteries, and lithium-ion batteries. Among these secondary batteries, lithium secondary batteries that generate electrical energy through the intercalation and deintercalation reactions of lithium ions (Li⁺) during charging and discharging are used in various applications, including electric vehicles, because they have high energy density while having excellent lightweight properties.

A lithium secondary battery includes a positive electrode; a negative electrode; an electrolyte interposed between the positive electrode and the negative electrode; and a separator impregnated with the electrolyte, wherein the positive electrode and the negative electrode each include an active material formed on a current collector. The positive electrode active material of the lithium secondary battery includes a lithium transition metal oxide or the like, and serves as a lithium ion source that determines the capacity and average voltage of the lithium-ion battery, and the negative electrode active material can store the lithium ions released from the positive electrode and then release the lithium ions, allowing current to flow through an external circuit. The electrolyte acts as a medium to allow lithium ions to move between the positive and negative electrodes in the battery.

Crystalline carbon materials such as natural graphite or artificial graphite or amorphous carbon materials have been used as negative electrode active materials for conventional lithium-ion batteries. In particular, natural graphite is known to exhibit higher capacity than artificial graphite. However, despite this high-capacity advantage, natural graphite is known to have inferior life characteristics compared to artificial graphite.

Natural graphite mostly has a plate-like shape, but spheroidized natural graphite is mainly used for the purpose of facilitating the electrode fabrication process, increasing the filling density, and improving the output characteristics. However, there is a problem in that the life characteristics of natural graphite deteriorate during repeated charge and discharge processes due to defects in the graphite structure, generated through the spheroidization process, and internal stress. On the other hand, although artificial graphite has inferior capacity compared to natural graphite, it has excellent life characteristics. Thus, recently, a mixture of natural graphite and artificial graphite has been applied as negative electrode materials to overcome the shortcomings of each of natural graphite and artificial graphite.

Background art related to the present disclosure is disclosed in Korean Patent No. 10-1564374 (published on Oct. 30, 2015; entitled “Method for producing artificial graphite negative electrode material for lithium secondary battery and artificial graphite negative electrode material for lithium secondary battery produced thereby”).

### SUMMARY

An object of the present disclosure is to provide a negative electrode active material having excellent durability and structural stability and high-capacity, high-output, and long-life characteristics.

Another object of the present disclosure is to provide a negative electrode active material having an excellent effect of preventing an increase in the thickness of the solid electrolyte interphase (SEI) and a decrease in the life, which are due to expansion of the graphite core during charging and discharging, by including a coating layer having excellent crystallinity formed on the outer surface of the graphite core.

Still another object of the present disclosure is to provide a negative electrode active material having excellent electrical conductivity, reversibility, and initial charge efficiency (ICE) characteristics.

Yet another object of the present disclosure is to provide a negative electrode active material having an increased crystal density.

Still yet another object of the present disclosure is to provide a negative electrode active material having excellent long-term stability (cyclability) and charge/discharge (C-rate) efficiency.

A further object of the present disclosure is to provide a negative electrode active material that may be included in large amounts when fabricating a negative electrode for a secondary battery.

Another further object of the present disclosure is to provide a negative electrode active material having excellent productivity and economic efficiency.

Still another further object of the present disclosure is to provide a method for producing the negative electrode active material.

Yet another further object of the present disclosure is to provide a secondary battery including the negative electrode active material.

One aspect of the present disclosure relates to a negative electrode active material. In one embodiment, the negative electrode active material includes: a first hollow core having a first hollow portion formed therein; and at least one composite particle packed in the first hollow portion, wherein the composite particle includes a graphite core, and a graphene layer and a first coating layer sequentially formed on the outer surface of the graphite core, wherein the first coating layer includes a hard coating layer, and the first coating layer and the first hollow core each have a higher hardness than the graphite core and the graphene layer.

In one embodiment, the graphite core may have an average size of 0.1 to 20 μm, the graphene layer may have a thickness of 5 to 500 nm, and the first coating layer may have a thickness of 300 nm to 1 μm.

In one embodiment, the graphene layer may include 1 to 10 layers, and the ratio of the peak intensity of the (002) plane to the peak intensity of the (101) plane in the X-ray diffraction (XRD) spectrum of the graphene layer may be 50 or more.

In one embodiment, the ratio of D-band peak intensity to G-band peak intensity (ID/I_{G}) in the Raman spectrum of the graphene layer may be 0.65 or less.

In one embodiment, the ratio of 2D-band peak intensity to G-band peak intensity (I_{2D}/I_{G}) in the Raman spectrum of the graphene layer may be 0.35 to 0.65.

In one embodiment, the Raman spectrum of the graphene layer may show the 2D-band peak in the wavenumber range of 2,660 to 2,720 cm⁻¹, the D-band peak in the wavenumber range of 1,320 to 1,370 cm⁻¹, and the G-band peak in the wavenumber range of 1,550 to 1,600 cm⁻¹.

In one embodiment, the first hollow core may have an inner diameter of 1.5 to 20 μm and a thickness of 5 to 1,000 nm.

In one embodiment, the composite particle may include a second coating layer formed on the outer surface of the first coating layer, wherein the second coating layer may include at least one of a soft coating layer, a medium coating layer, and a hard coating layer.

In one embodiment example, the hard coating layer may have a pencil hardness of 4H or higher as measured according to ISO 15184 and a density higher than 1.8 g/cm³, the medium coating layer may have a pencil hardness ranging from 2H to lower than 4H as measured according to ISO 15184 and a density ranging from higher than 1.5 g/cm³ to 1.8 g/cm³, and the soft coating layer may have a pencil hardness lower than 2H as measured according to ISO 15184 and a density of 1.5 g/cm³ or lower.

In one embodiment, the first hollow core may have a pencil hardness of 4H or higher as measured according to ISO 15184, an oxygen transmission rate of 4.0×10⁻² darcy or less, and a resistivity of 10 μΩ·m or less.

In one embodiment, the full width at half maximum (FWHM) of X-ray diffraction angle (2θ) for the (002) plane of the first hollow core, measured using CuKα radiation, may be 3° to 6°.

In one embodiment, the X-ray diffraction peak of the first hollow core, measured using CuKα radiation, may satisfy the following Equation 1:

2≤I(002)/I(100)≤6 [Equation 1]
wherein I(002) represents the peak intensity of the (002) plane of the first hollow core, and I(100) represents the peak intensity of the (100) plane of the first hollow core.

In one embodiment, the composite particle may include 30 to 85 wt % of the graphite core, 0.1 to 30 wt % of the graphene layer, and 1 to 50 wt % of the first coating layer.

In one embodiment, the negative electrode active material may further include a conductive component dispersed in the first hollow portion, wherein the conductive component may include at least one of graphite particles, graphene, and conductive hard coating particles.

In another embodiment, the negative electrode active material may include: a primary particle including a first hollow core having a first hollow portion formed therein and at least one composite particle packed in the first hollow portion; and a secondary particle including a second hollow core having a second hollow portion formed therein and at least one primary particle packed in the second hollow portion, wherein the composite particle includes a graphite core, and a graphene layer and a first coating layer sequentially formed on the outer surface of the graphite core, wherein the first coating layer includes a hard coating layer, and the first coating layer, the first hollow core, and the second hollow core each have a higher hardness than the graphite core and the graphene layer.

Another aspect of the present disclosure relates to a method for producing the negative electrode active material. In one embodiment, the method for producing the negative electrode active material includes steps of: producing composite particles; producing dry powder by drying a mixed slurry comprising the composite particles and a solvent; and producing a first intermediate using the dry powder and a hard coating material, wherein the first intermediate includes a first hollow core having a first hollow portion formed therein, and at least one composite particle packed in the first hollow portion, wherein the composite particle includes a graphite core, and a graphene layer and a first coating layer sequentially formed on the outer surface of the graphite core, wherein the first coating layer includes a hard coating layer, and the first coating layer and the first hollow core each have a higher hardness than the graphite core and the graphene layer.

In one embodiment, the step of producing composite particles may include steps of: preparing a first composition including graphite powder, graphene, and a hard coating material;
placing the first composition in a chamber, raising the temperature inside the chamber to 500 to 1,100° C., and reducing the pressure inside the chamber to below atmospheric pressure;
introducing a hydrocarbon gas and a buffer gas into the reduced-pressure chamber to contact the first composition; and performing heat treatment by gradually increasing the pressure inside the chamber while maintaining the raised temperature.

In one embodiment, the graphene may be formed by milling the graphite powder.

In one embodiment, the hard coating material may have an average particle diameter of 5 nm to 1,000 nm.

In another embodiment, the method for producing the negative electrode active material includes steps of: producing composite particles; producing dry powder by drying a mixed slurry comprising the composite particles and a solvent; and producing a second intermediate using the dry powder and a hard coating material, wherein the second intermediate includes a primary particle including a first hollow core having a first hollow portion formed therein and at least one composite particle packed in the first hollow portion, and a secondary particle including a second hollow core having a second hollow portion formed therein and at least one primary particle packed in the second hollow portion, and the composite particle includes a graphite core, and a graphene layer and a first coating layer sequentially formed on the outer surface of the graphite core, wherein the first coating layer includes a hard coating layer, and the first coating layer, the first hollow core, and the second hollow core each have a higher hardness than the graphite core and the graphene layer.

Another aspect of the present disclosure relates to a secondary battery including the negative electrode active material. In one embodiment, the secondary battery includes a positive electrode; a negative electrode; and an electrolyte formed between the positive electrode and the negative electrode, wherein the negative electrode includes the negative electrode active material.

The negative electrode active material according to the present disclosure has excellent durability and structural stability and high-capacity, high-output, and long-life characteristics. In addition, the negative electrode active material has an excellent effect of preventing an increase in the thickness of the solid electrolyte interphase (SEI) and a decrease in the life, which are due to expansion of the graphite core during charging and discharging, by having a structure including the composite particle including the coating layer having excellent crystallinity formed on the outer surface of the graphite core, and the secondary particle including the composite particle packed in the hollow core having excellent crystallinity. Further, the negative electrode active material may have excellent electrical conductivity, reversibility, and initial charge efficiency (ICE) characteristics. Further, the negative electrode active material has an increased crystal density and excellent long-term stability (cyclability) and charge/discharge (C-rate) efficiency, and may be included in large amounts when fabricating a negative electrode for a secondary battery. In addition, the negative electrode active material may have excellent productivity and economic efficiency.

### BRIEF DESCRIPTION OF THE DRAWINGS

FIG. 1 illustrates a composite particle according to one embodiment of the present disclosure.

FIG. 2 illustrates a negative electrode active material according to one embodiment of the present disclosure.

FIG. 3 illustrates a negative electrode active material according to another embodiment of the present disclosure.

FIG. 4 is a graph showing X-ray diffraction (XRD) spectra of composite particles with different coating layers in the negative electrode active materials according to Examples 1 and 3.

FIG. 5 is a graph showing X-ray diffraction (XRD) spectra of composite particles with different coating layers in the negative electrode active materials according to Examples 1 and 3.

FIG. 6 shows X-ray diffraction (XRD) spectra of Examples 1 and 3.

FIG. 7 shows the results of evaluating the cycle life characteristics of Example 1 and Comparative Example 1.

FIG. 8 shows the results of a specific charge capacity test for Examples 1 and 2 and Comparative Examples 1 and 2.

FIG. 9 shows the results of evaluating the rate characteristics of Examples 1 and 2 and Comparative Examples 1 and 2.

### DETAILED DESCRIPTION OF THE ILLUSTRATED EMBODIMENTS

In the following description, the detailed description of related publicly-known technology or configuration will be omitted when it may unnecessarily obscure the subject matter of the present disclosure.

In addition, the terms used in the following description are terms defined taking into consideration their functions in the present disclosure, and may be changed in accordance with the option of a user or operator or a usual practice. Accordingly, the definition of the terms should be made based on the contents throughout the present specification.

### Negative Electrode Active Material

One aspect of the present disclosure relates to a negative electrode active material.

### First Embodiment

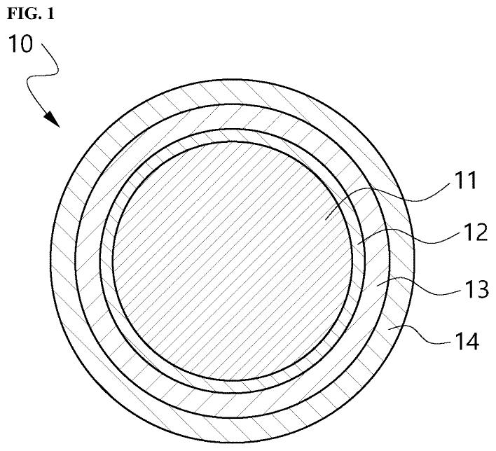

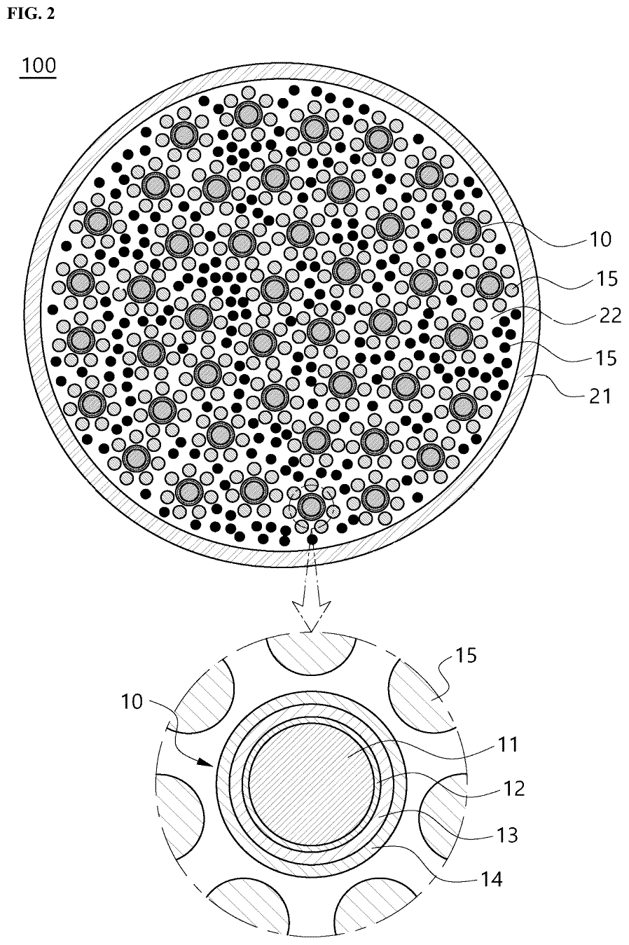

FIG. 1 illustrates a composite particle according to one embodiment of the present disclosure, and FIG. 2 illustrates a negative electrode active material according to one embodiment of the present disclosure.

Referring to FIGS. 1 and 2, the negative electrode active 100 material includes: a first hollow core 21 having a first hollow portion 22 formed therein; and at least one composite particle 10 packed in the first hollow portion 22. The composite particle 10 includes a graphite core 11, and a graphene layer 12 and a first coating layer 13 sequentially formed on the outer surface of the graphite core 11. The first coating layer 13 includes a hard coating layer, and the first coating layer 13 and the first hollow core 21 each have a higher hardness than the graphite core 11 and the graphene layer 12.

Hereinafter, each component of the negative electrode active material according to the first embodiment will be described in detail.

(1) First hollow core: The first hollow core 21 includes the first hollow portion 22 formed therein, and the composite particle 10 is packed in the first hollow portion 22. The first hollow core 21 may be spherical or oval in shape. For example, the first hollow core 21 may be spherical in shape.

In one embodiment, the first hollow portion 22 may have an average diameter of 1.5 to 20 μm (a radius of 0.75 to 10 μm). Under this condition, the negative electrode active material may have excellent high-output and long-life characteristics while being prevented from being destroyed by volume expansion of the composite particle during charging and discharging. For example, the average diameter may be 2 to 20 μm, 3 to 20 μm, 6 to 20 μm, or 10 to 20 μm. For example, the average diameter may be 1.5, 1.6, 1.7, 1.8, 1.9, 2, 3, 4, 5, 6, 7, 8, 9, 10, 11, 12, 13, 14, 15, 16, 17, 18, 19 or 20 μm.

In one embodiment, the first hollow core 21 may have a thickness of 5 to 1,000 nm. Under this condition, the negative electrode active material may have excellent hardness and mechanical strength, and thus may be prevented from being broken or damaged even when the composite particle 10 expands during charging and discharging. For example, the first hollow core may have a thickness of 5 to 300 nm, 5 to 250 nm, 5 to 200 nm, 10 to 200 nm, or 10 to 50 nm.

In one embodiment, the first hollow core 21 has a higher hardness than the graphite core 11 and the graphene layer 12. Under this condition, the negative electrode active material may have excellent hardness and mechanical strength, and thus may be prevented from being broken or damaged even when the composite particle 10 expands during charging and discharging.

In one embodiment, the first hollow core 21 may have a density of 1.8 to 2.5 g/cm³. Under this condition, the negative electrode active material may have excellent structural stability and lightweight characteristics. For example, the first hollow core 21 may have a density of 1.8 to 2.1 g/cm³.

In another embodiment, the first hollow core 21 may have a density of less than 1.8 g/cm³. Under this condition, the negative electrode active material may have excellent structural stability and lightweight characteristics. For example, the first hollow core may have a density of 0.3 to 1.7 g/cm³.

In one embodiment, the first hollow core 21 may have a BET specific surface area of 100 m²/g or less. Under this condition, the negative electrode active material may have excellent structural stability.

In another embodiment, the first hollow core 21 may have a BET specific surface area of more than 100 m²/g. Under this condition, the negative electrode active material may have excellent structural stability. For example, the BET specific surface area may be 110 to 500 m²/g.

In one embodiment, the first hollow core 21 may have an impurity content of 100 ppm or less. Under this condition, the negative electrode active material may have excellent electrical conductivity.

In another embodiment, the first hollow core 21 may have an impurity content of 500 ppm or more. Under this condition, the negative electrode active material may have excellent electrical conductivity. For example, the impurity content may be 500 to 3,000 ppm.

In one embodiment, the first hollow core 21 may have a resistivity of 10 μΩ·m or less. Under this condition, the negative electrode active material may have excellent electrical conductivity. For example, the first hollow core 21 may have a resistivity of 5 μΩ·m or less, or 3 to 5 μΩ·m.

In one embodiment, the first hollow core 21 may have a pencil hardness of 4H or higher as measured according to ISO 15184. Under this condition, the first hollow core may have excellent durability and strength, and the effect of preventing the first hollow core (or negative electrode active material) from being broken or damaged during charging and discharging may be excellent. For example, the first hollow core 21 may have a pencil hardness of 4H to 6H. For example, the first hollow core 21 may have a pencil hardness of 4H, 5H or 6H.

In one embodiment, the first hollow core 21 may have an oxygen transmission rate of 4.0×10⁻² darcy or less, which is a constant value calculated by Darcy's law. Under this condition, the negative electrode active material may have excellent gas impermeability and excellent electrical properties and durability, and the effect of preventing the secondary battery from catching fire in a high-temperature environment may be excellent.

For example, the first hollow core may have an oxygen transmission rate of 4.0×10⁻⁵ darcy or less, or 4.0×10⁻⁸ darcy to 4.0×10⁻⁵ darcy. For example, the first hollow core may have an oxygen transmission rate of 4.0×10⁻² darcy, 4.0×10⁻³ darcy, 4.0×10⁻⁴ darcy, 4.0×10⁻⁵ darcy, 4.0×10⁻⁶ darcy, 4.0×10⁻⁷ darcy or 4.0×10⁻⁸ darcy.

In one embodiment, the oxygen transmission rate (OTR) may be measured by a known method according to ASTM D3985 or JIS K7126. For example, the oxygen transmission rate of the first hollow core may be measured by expressing the volume of oxygen gas, which passes through the first hollow core (first hollow portion) by differential pressure, as a function of time, and measuring the permeability coefficient and transmission rate of oxygen using the expressed volume.

For example, the oxygen transmission rate of the first hollow core may be measured using an instrument such as OX-TRAN Model 2/21 or OX-TRAN Model 2/61 commercially available from Mocon, Inc.

In one embodiment, the full width at half maximum (FWHM) of X-ray diffraction angle (2θ) for the (002) plane of the first hollow core 21, measured using CuKα radiation, may be 3° to 6°. In this FWHM range, the first hollow core may have high hardness, excellent durability and crystallinity, and excellent electrical conductivity, and thus the negative electrode active material may have high-capacity and high-output characteristics. For example, the FWHM of X-ray diffraction angle (2θ) for the first hollow core may be 3.5° to 5.8°. For example, the FWHM of the X-ray diffraction (XRD) peak of the first hollow core, measured using CuKα radiation of wavelength 1.54178 Å at a 2θ angle of 10 to 70° with a step size of 0.01°, may be 3° to 6°. For example, the FWHM of X-ray diffraction angle (2θ) for the (002) plane of the first hollow core 21, measured using CuKα radiation, may be 3°, 3.1°, 3.2°, 3.3°, 3.4°, 3.5°, 3.6°, 3.7°, 3.8°, 3.9°, 4°, 4.1°, 4.2°, 4.3°, 4.4°, 4.5°, 4.6°, 4.7°, 4.8°, 4.9°, 5°, 5.1°, 5.2°, 5.3°, 5.4°, 5.5°, 5.6°, 5.7°, 5.8°, 5.9° or 6°.

In one embodiment, the X-ray diffraction peak of the first hollow core 21, measured using CuKα radiation, may satisfy the following Equation 1:

$$2 \leq I ( 002 ) / I ( 100 ) \leq 6 \qquad [ Equation 1 ]$$

wherein I(002) represents the peak intensity of the (002) plane of the first hollow core, and I(100) represents the peak intensity of the (100) plane of the first hollow core.

When the condition of Equation 1 is satisfied, the first hollow core may have high hardness, excellent durability and crystallinity, and excellent electrical conductivity, and thus the negative electrode active material may have high-capacity and high-output characteristics. For example, I(002)/I(100) in Equation 1 may be 2.5 to 5.5, 2.5 to 5, or 2 to 4.5. For example, I(002)/I(100) in Equation 1 may be 2, 2.1, 2, 2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9 or 6.

In one embodiment, the first hollow core 21 may be included in an amount of 1 to 50 wt % based on the total weight of the negative electrode active material. When the first hollow core 21 is included in an amount within the above range, it may have excellent structural stability, miscibility, and durability, and the negative electrode active material may have excellent high-capacity and high-output characteristics. For example, the first hollow core may be included in an amount of 1 to 45 wt %, 1 to 50 wt %, 1 to 40 wt %, 1 to 30 wt %, 1 to 25 wt %, or 1 to 20 wt %. For example, the first hollow core may be included in an amount of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 wt %.

(2) Composite particle: The composite particle 10 includes a graphite core 11, and a graphene layer 12 and a first coating layer 13 sequentially formed on the outer surface of the graphite core 11.

In one embodiment, the composite particle 10 may be spherical, polyhedral, oval or irregular in shape. For example, it may be spherical in shape.

In one embodiment, the composite particle 10 may have an average size of 0.5 to 23 μm. Here, the size may refer to the maximum length or diameter (size) of the composite particle 10. Under this condition, the composite particle 10 may have high-capacity and high-output characteristics, and the negative electrode active material may be prevented from being broken or destroyed by expansion of the composite particle 10, and thus may have excellent long-life characteristics. For example, the composite particle 10 may have an average size of 1 to 20 μm, 1.5 to 15 μm, 2 to 15 μm, 3 to 15 μm, 3 to 10 μm, or 3 to 8 μm. For example, the composite particle 10 may have an average size of 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22 or 23 μm.

In one embodiment, the composite particle 10 may be included in an amount of 25 to 80 wt % based on the total weight of the negative electrode active material. When the composite particle 10 is included in an amount within the above range, it may have excellent miscibility and durability, and the negative electrode active material may have excellent high-capacity and high-output characteristics. For example, the composite particle 10 may be included in an amount of 25 to 70 wt %. As another example, the composite particle may be included in an amount of 25 to 75 wt %, 25 to 65 wt %, 25 to 60 wt %, 25 to 50 wt %, 25 to 45 wt %, or 30 to 45 wt %. For example, the composite particle 10 may be included in an amount of 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79 or 80 wt %.

(2-1) Graphite core: The graphite core may be included to ensure high-capacity and high-output characteristics. In one embodiment, the graphite core may be spherical, polyhedral, oval or irregular in shape. For example, it may be spherical in shape.

The graphite core may include at least one of natural graphite, artificial graphite, and expandable graphite.

In one embodiment, the graphite core 11 may have an average size of 0.1 to 20 μm. Here, the size may refer to the maximum length or diameter (size) of the graphite core 11.

For example, the graphite core 11 may be flake-like, oval or spherical in shape. Under this condition, the graphite core 11 may have high-capacity and high-output characteristics, and the negative electrode active material may be prevented from being broken or destroyed by expansion of the graphite core 11, and thus may have excellent long-life characteristics. For example, the graphite core 11 may have an average size of 0.5 to 20 μm, 1 to 18 μm, 1 to 16 μm, 2 to 15 μm, 3 to 15 μm, 3 to 10 μm, or 3 to 7 μm. For example, the graphite core 11 may have an average size of 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19 or 20 μm.

In one embodiment, the graphite core 11 may exhibit relatively high crystallinity. The crystallinity may be determined by conventional X-ray diffraction (XRD) analysis. Under this condition, the graphite core 11 may have excellent durability and structural stability, and thus prevent destruction and breakage of the negative electrode active material, and the negative electrode active material may have excellent long-life characteristics and excellent electrical conductivity, strength, and high-output characteristics.

(2-2) Graphene layer: The graphene layer 12 may be included to improve the electrical conductivity, strength, and high-output characteristics of the negative electrode active material by enhancing the electrical conductivity, durability, and structural stability.

For example, the graphene layer 12 may be formed on at least a portion of the outer surface of the graphite core 11 by milling the graphite. For example, the graphene layer 12 may be formed as a shell surrounding the outer surface of the graphite core 11.

In one embodiment, the graphene layer 12 may be formed so that the graphene layer 12 is included in an amount of 1 to 10 wt % based on the weight of the graphite core 11. When the graphene layer 12 is included in an amount within the above range, the negative electrode active material may have excellent electrical conductivity and capacity characteristics, as well as excellent high-output and long-life characteristics.

In one embodiment, the graphene layer 12 may have a thickness of 5 to 500 nm. Under this condition, the negative electrode active material may have excellent durability, structural stability, and electrical conductivity, as well as high-output characteristics. For example, the graphene layer 12 may have a thickness of 5 to 400 nm, 5 to 300 nm, 10 to 250 nm, 10 to 200 nm, 10 to 150 nm, 15 to 100 nm, or 30 to 70 nm.

The graphene layer 12 may be formed by a process including a step of separating graphite into layers while refining the graphite particles of the graphite core 11 formed of at least one of natural graphite, artificial graphite, and expandable graphite by a milling process. When the graphene layer 12 is formed under these conditions, it may have excellent crystallinity and electrical properties.

In one embodiment, the graphene layer 12 may include a layered structure consisting of 1 to 10 layers. Under this condition, the graphene layer 12 may have excellent crystallinity, and the negative electrode active material may have excellent electrical conductivity and capacity characteristics, as well as excellent high-output and long-life characteristics. For example, the graphene layer 12 may include a layered structure consisting of 2 to 8 layers or 2 to 5 layers.

In one embodiment, the X-ray diffraction (XRD) spectrum of the graphene layer 12, measured using CuKα radiation of wavelength 1.54 to 2.0 Å, may have a peak at a diffraction angle (2θ) of 25 to 28° in the (002) plane, and have a peak at a diffraction angle (2θ) of 42 to 47° in the (101) plane.

In one embodiment, the ratio of the peak intensity of the (002) plane to the peak intensity of the (101) plane in the X-ray diffraction (XRD) spectrum of the graphene layer 12 may be 50 or more. Under this condition, the graphene layer may have excellent durability, and the negative electrode active material may have excellent electrical conductivity and capacity characteristics, as well as excellent high-output and long-life characteristics. For example, the ratio of the peak intensity of the (002) plane to the peak intensity of the (101) plane in the X-ray diffraction (XRD) spectrum of the graphene layer 12, measured using CuKα radiation of wavelength 1.54 to 2.0 Å, may be 70 or more, 80 or more, 100 or more, 200 or more, 300 or more, or 50 to 10,000.

In one embodiment, the ratio of D-band peak intensity to G-band peak intensity (ID/I_{G}) in the Raman spectrum of the graphene layer 12 may be 0.65 or less. Under this condition, the graphene layer 12 may have excellent durability and electrical conductivity, and thus the negative electrode active material may have high-capacity and high-output characteristics. For example, the ratio of D-band peak intensity to G-band peak intensity (ID/I_{G}) in the Raman spectrum of the graphene layer 12 may be 0.65 or less, 0.55 or less, or 0.10 to 0.55.

For example, in the Raman spectrum of the graphene layer 12, measured under 532 nm continuous wave (CW) laser excitation, the 1G band peak may appear in the wavelength range of 1,560 to 1,600 cm⁻¹, and the 1D-band peak may appear in the wavelength range of 2,600 to 2,800 cm⁻¹.

In one embodiment, the ratio of 2D-band peak intensity to G (1G)-band peak intensity (I_{2D}/I_{G}) in the Raman spectrum of the graphene layer 12 may be 0.35 to 0.65. Under this condition, the graphene layer 12 may have excellent durability and electrical conductivity, and thus the negative electrode active material may have high-capacity and high-output characteristics. For example, the ratio of 2D-band peak intensity to G (1G)-band peak intensity (I_{2D}/I_{G}) in the Raman spectrum of the graphene layer 12 may be 0.65 or less, or 0.35 to 0.65.

In one embodiment, in the Raman spectrum of the graphene layer 12, measured under 532-nm CW laser excitation, the Raman shift of the 2D band may have a peak in the wavelength range of 2,680 to 2,725 cm⁻¹. Under this condition, the graphene layer may have minimized electrical resistance, and the negative electrode active material may have excellent electrical conductivity and high-output characteristics, may be prevented from capacity reduction, and may have excellent long-life characteristics.

In one embodiment, the Raman spectrum of the graphene layer 12, measured under 532-nm CW laser excitation, may show the 2D-band peak in the wavenumber range of 2,660 to 2,720 cm⁻¹, the D-band peak in the wavenumber range of 1,320 to 1,370 cm⁻¹, and the G-band peak in the wavenumber range of 1,550 to 1,600 cm⁻¹. Under these conditions, the graphene layer may have minimized electrical resistance, and the negative electrode active material may have excellent electrical conductivity and high-output characteristics, may be prevented from capacity reduction, and may have excellent long-life characteristics.

Meanwhile, the Raman spectra of the graphene layer 12, measured under two CW laser excitations, that is, 532-nm excitation with a fixed laser power of 50 mW and 785-nm excitation with a fixed laser power of 20 mW, may show the 1D-band peak in the wavenumber range of 2,600 to 2,780 cm⁻¹, the 1G-band peak in the wavenumber range of 1,560 to 1,600 cm⁻¹, and the 2D-band peak in the wavenumber range of 2,680 to 2,725 cm⁻¹. Under these conditions, the graphene layer may have minimized electrical resistance, and the negative electrode active material may have excellent electrical conductivity and high-output characteristics, may be prevented from capacity reduction, and may have excellent long-life characteristics.

In one embodiment, in the Raman spectrum of the graphene layer, measured under 785-nm CW laser excitation, the ratio of 1D-band peak intensity to 1G-band peak intensity (ID/I_{G}) may be 0.15 to 0.40. Under this condition, the graphene layer may have minimized electrical resistance, and the negative electrode active material may have excellent electrical conductivity and high-output characteristics, may be prevented from capacity reduction, and may have excellent long-life characteristics. For example, the ratio of 1D-band peak intensity to 1G-band peak intensity (ID/I_{G}) may be 0.25 to 0.4.

In one embodiment, the above-described properties of the graphene layer 12 may be obtained at desired values through a milling process for graphite particles.

For example, the ratio of D-band peak intensity to G-band peak intensity (ID/I_{G}) in the Raman spectra may be changed from 0.05 to 0.53 for natural graphite and from 0.1 to 0.53 for artificial graphite through the milling process.

(2-3) First coating layer: The first coating layer 13 is formed on the outer surface of the graphene layer 12 and includes a hard coating layer (or first hard coating layer). When the first coating layer is formed, the composite particle may have excellent structural stability, and the graphite core may be prevented from being broken or damaged during charging and discharging, and may have excellent electrical conductivity and high-output characteristics.

In one embodiment, the first coating layer may have a thickness of 300 nm to 1 μm. Under this condition, the first coating layer may have excellent hardness and mechanical strength, and the graphite core may be prevented from being broken or damaged during charging and discharging while having excellent electrical properties and high-capacity characteristics. For example, the thickness of the first coating layer may be 300 to 900 nm, 300 to 800 nm, 300 to 700 nm, 300 to 600 nm, or 300 to 500 nm.

In one embodiment, the first coating layer may have a density of 1.8 to 2.5 g/cm³. Under this condition, the negative electrode active material may have excellent structural stability and lightweight characteristics. For example, the first coating layer may have a density of 1.8 to 2.1 g/cm³.

In one embodiment, the first coating layer may have a BET specific surface area of 100 m²/g or less. Under this condition, the negative electrode active material may have excellent structural stability.

In one embodiment, the first coating layer may have an impurity content of 100 ppm or less. Under this condition, the negative electrode active material may have excellent electrical conductivity.

In one embodiment, the first coating layer may have a resistivity of 10 μΩ·m or less. Under this condition, the negative electrode active material may have excellent electrical conductivity. For example, the resistivity of the first coating layer may be 3 to 8 μΩ·m or 3 to 5 μΩ·m.

In one embodiment, the first coating layer may have a pencil hardness of 4H or higher as measured according to ISO 15184. Under this condition, the first coating layer has excellent mechanical strength properties such as hardness and durability, and the graphite core may be prevented from being broken or damaged during charging and discharging while the negative electrode active material has excellent electrical properties and high-capacity characteristics. For example, the first coating layer may have a pencil hardness of 4H to 6H. For example, the first coating layer may have a pencil hardness of 4H, 5H or 6H.

(2-4) Second coating layer: Referring to FIG. 1, the composite particle 10 may further include a second coating layer 14 formed on the outer surface of the first coating layer 13. When the second coating layer is further formed, the composite particle may have excellent structural stability, which may prevent breakage or damage to the graphite core, and thus the negative electrode active material may be prevented from capacity reduction and have excellent long-life characteristics.

The second coating layer may include at least one of a soft coating layer, a medium coating layer, and a hard coating layer.

In one embodiment, the second coating layer may have a thickness of 5 nm to 2 μm. Under this condition, the composite particle may have excellent structural stability, which may prevent breakage or damage to the graphite core, and thus the negative electrode active material may be prevented from capacity reduction and have excellent long-life characteristics. For example, the second coating layer may have a thickness of 10 nm to 1.5 μm, 30 nm to 1 μm, 50 nm to 1 μm, 80 to 700 nm, 90 to 500 nm, or 100 to 350 nm.

(2-4A) Soft coating layer: In one embodiment, the soft coating layer may be fabricated by calcining a soft coating material. In one embodiment, the soft coating material may include at least one of pitch, coke, and carbon precursors formed from other organic materials. For example, the pitch may include at least one of pyrolysis fuel oil pitch and coal tar pitch.

In one embodiment, the soft coating layer may have a thickness of 5 to 500 nm. Under this condition, the soft coating layer may have excellent flexibility and mechanical strength, which may prevent damage to the graphite core during charging and discharging and prevent breakage or damage to the negative electrode active material. For example, the thickness of the soft coating layer may be 5 to 150 nm, 5 to 100 nm, 5 to 60 nm, 5 to 30 nm, or 5 to 20 nm.

In one embodiment, the soft coating layer may have a pencil hardness of less than 2H as measured according to ISO 15184. Under this condition, the soft coating layer may have excellent flexibility and mechanical strength, which may prevent damage to the graphite core during charging and discharging and prevent breakage or damage to the negative electrode active material. For example, the pencil hardness may be B to 1H.

In one embodiment, the soft coating layer may have a density of 1.5 g/cm³ or less. Under this condition, the negative electrode active materials may have excellent structural stability and lightweight characteristics. For example, the soft coating layer may have a density of 0.3 to 1.4 g/cm³.

In one embodiment, the soft coating layer may have a BET specific surface area of 300 m²/g or more. Under this condition, the negative electrode active material may have excellent structural stability. For example, the BET specific surface area may be 300 to 2,500 m²/g.

In one embodiment, the soft coating layer may have an impurity content of 1,000 ppm or more. Under this condition, the negative electrode active material may have excellent electrical conductivity. For example, the impurity content may be 1,000 to 5,000 ppm.

In one embodiment, the soft coating layer may have a resistivity of 50 μΩ·m or more. Under this condition, the negative electrode active material may have excellent electrical conductivity. For example, the resistivity may be 50 to 300 μΩ·m.

(2-4B) Medium coating layer: In one embodiment, the medium coating layer may be formed by heat-treating at least one of a hydrocarbon gas and carbon black. For example, the hydrocarbon gas may include at least one of methane (CH₄), ethane (C₂H₆), propane (C₃H₈), butane (C₄H₁₀), and pentane (C₅H₁₂).

In one embodiment, the medium coating layer may be amorphous or crystalline. Under this condition, the medium coating layer may have excellent strength and durability.

In one embodiment, the medium coating layer may have a thickness of 5 to 500 nm. Under this condition, the medium coating layer may have excellent hardness, flexibility, and mechanical strength, which may prevent damage to the graphite core during charging and discharging and prevent breakage or damage to the negative electrode active material. For example, the thickness may be 5 to 300 nm, 5 to 100 nm, 5 to 80 nm, 5 to 60 nm, 5 to 30 nm, or 5 to 20 nm.

In one embodiment, the medium coating layer may have a pencil hardness ranging from 2H to lower than 4H as measured according to ISO 15184. Under this condition, the medium coating layer may prevent damage to the graphite core during charging and discharging and prevent breakage or damage to the negative electrode active material, thereby providing excellent long-life characteristics. For example, the pencil hardness may be 2H to 3.5H. For example, the pencil hardness may be 2H, 3H or 3.5H.

In one embodiment, the medium coating layer may have a density ranging from higher than 1.5 g/cm³ to 1.8 g/cm³. Under this condition, the negative electrode active material may have excellent structural stability and lightweight characteristics. For example, the medium coating layer may have a density ranging from higher than 1.5 g/cm³ to 1.7 g/cm³.

In one embodiment, the medium coating layer may have a BET specific surface area of 100 to 200 m²/g. Under this condition, the negative electrode active material may have excellent structural stability.

In one embodiment, the medium coating layer may have an impurity content of 500 ppm or less. Under this condition, the negative electrode active material may have excellent electrical conductivity.

In one embodiment, the medium coating layer may have a resistivity of 20 to 40 μΩ·m. Under this condition, the negative electrode active material may have excellent electrical conductivity.

(2-4C) Hard coating layer (second hard coating layer): When the hard coating layer is included, the composite particle may have excellent structural stability, and the graphite core may be prevented from being broken and damaged during charging and discharging while the negative electrode active material has excellent electrical conductivity and high-output characteristics.

In one embodiment, the hard coating layer may have a thickness of 5 nm to 500 nm. Under this condition, the hard coating layer may have excellent hardness and mechanical strength, the graphite core may be prevented from being broken or damaged during charging and discharging while the negative electrode active material has having excellent electrical properties and high-capacity characteristics. For example, the thickness of the hard coating layer may be 5 to 400 nm, 5 to 250 nm, 5 to 100 nm, 5 to 80 nm, 5 to 50 nm, or 5 to 25 nm.

In one embodiment, the hard coating layer may have a density of 1.8 to 2.5 g/cm³. Under this condition, the negative electrode active material may have excellent structural stability and lightweight characteristics. For example, the hard coating layer may have a density of 1.8 to 2.1 g/cm³.

In one embodiment, the hard coating layer may have a BET specific surface area of 100 m²/g or less. Under this condition, the negative electrode active material may have excellent structural stability.

In one embodiment, the hard coating layer may have an impurity content of 100 ppm or less. Under this condition, the negative electrode active material may have excellent electrical conductivity.

In one embodiment, the hard coating layer may have a resistivity of 10 μΩ·m or less. Under this condition, the negative electrode active material may have excellent electrical conductivity. For example, the resistivity may be 3 to 8 μΩ·m, or 3 to 5 μΩ·m.

In one embodiment, the hard coating layer may have a pencil hardness of 4H or higher as measured according to ISO 15184. Under this condition, the hard coating layer may have excellent mechanical strength properties such as hardness and durability, and the graphite core may be prevented from being broken or damaged during charging and discharging while the negative electrode active material has excellent electrical properties and high-capacity characteristics. For example, the hard coating layer may have a pencil hardness of 4H to 6H. For example, the hard coating layer may have a pencil hardness of 4H, 5H or 6H.

In one embodiment, the hard coating layer may have a higher hardness than the medium coating layer and the soft coating layer, and the medium coating layer may have a higher hardness than the soft coating layer.

In one embodiment, the second coating layer may include a soft (or medium) coating layer and a medium (or soft) coating layer sequentially formed on the outer surface of the first coating layer.

For example, the second coating layer may include the soft coating layer and the medium coating layer at a weight ratio of 1:0.5 to 1:4. When the soft coating layer and the medium coating layer are included at a weight ratio within the above range, the negative electrode active material may be prevented from being broken and destroyed, and may have excellent electrical conductivity, high-output, and long-life characteristics. For example, the soft coating layer and the medium coating layer may be included at a weight ratio of 1:1 to 1:2. For example, the soft coating layer and the medium coating layer may be included at a weight ratio of 1:0.5, 1:1, 1:1.5, 1:2, 1:2.5, 1:3, 1:3.5 or 1:4.

In another embodiment, the second coating layer may include a soft (or medium) coating layer, a medium (or soft) coating layer, and a hard coating layer (second hard coating layer) sequentially formed on the outer surface of the first coating layer.

For example, the second coating layer may include the soft coating layer, the medium coating layer, and the hard coating layer at a weight ratio of 1:0.5 to 4:0.5 to 6. When the soft coating layer, the medium coating layer, and the hard coating layer are included at a weight ratio within the above range, the graphite core may be prevented from being damaged, and at the same time, the negative electrode active material may be prevented from being broken and destroyed and may have excellent electrical conductivity, high-output, and long-life characteristics. For example, these layers may be included at a weight ratio of 1:1 to 3:1 to 5 or 1:1 to 2:1.5 to 4.

In one embodiment, the graphite core may be included in an amount of 30 to 85 wt % based on the total weight of the composite particle. When the graphite core is included in an amount within the above range, the composite particle may have excellent high-output and electrical conductivity characteristics, as well as excellent long-life characteristics. For example, the graphite core may be included in an amount of 30 to 80 wt %, 35 to 80 wt %, 35 to 70 wt %, or 35 to 60 wt %. For example, the graphite core may be included in an amount of 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79 or 80 wt %.

In one embodiment, the graphene layer may be included in an amount of 0.1 to 30 wt % based on the total weight of the composite particle. When the graphene layer is included in an amount within the above range, the composite particle may have excellent high-output and electrical conductivity characteristics, as well as excellent long-life characteristics. For example, the graphene layer may be included in an amount of 1 to 30 wt %, 1 to 20 wt %, or 3 to 15 wt %. For example, the graphene layer may be included in an amount of 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 wt %.

In one embodiment, the first coating layer may be included in an amount of 1 to 50 wt % based on the total weight of the composite particle. When the first coating layer is included in an amount within the above range, the composite particle may have excellent hardness and structural stability, the graphite core may be prevented from broken and damaged during charging and discharging, and the composite particle may have excellent high-output and electrical conductivity characteristics, as well as excellent long-life characteristics. For example, the first coating layer may be included in an amount of 1 to 45 wt %, 5 to 45 wt %, 10 to 45 wt %, 15 to 45 wt %, or 15 to 30 wt %. For example, the first coating layer may be included in an amount of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 wt %.

In one embodiment, the second coating layer may be included in an amount of 1 to 40 wt % based on the total weight of the composite particle. When the second coating layer is included in an amount within the above range, the composite particle may have excellent hardness and structural stability, the graphite core may be prevented from broken and damaged during charging and discharging, and the composite particle may have excellent high-output and electrical conductivity characteristics, as well as excellent long-life characteristics. For example, the second coating layer may be included in an amount of 1 to 35 wt %, 5 to 30 wt %, 10 to 25 wt %, 15 to 25 wt %, or 15 to 20 wt %. For example, the second coating layer may be included in an amount of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40 wt %.

(3) Conductive component: Referring to FIG. 2, the negative electrode active material may further include a conductive component 15 dispersed in the first hollow portion 22, wherein the conductive component 15 may include at least one of graphite particles, graphene, and conductive hard coating particles. When the conductive component is included, the negative electrode active material may have excellent electrical conductivity and high-output characteristics, may be prevented from capacity reduction, and may have long-life characteristics.

The conductive component may enhance the conductive network inside and outside the negative electrode active material. The conductive component may act not only as an internal current collector, but also as an electrochemically active material. When the composite particle and the conductive component are packed in the first hollow portion, a low-resistance path may be stably formed, thereby ensuring a stable ion charging/discharging path and reducing the internal resistance (contact resistance) of the negative electrode active material.

Referring to FIG. 2, the conductive component 15 may be packed and dispersed between the composite particles 10 in the first hollow portion 22 to form a space, and when the composite particles 10 expand, the conductive component 15 may spatially absorb the expansion.

In one embodiment, the packing ratio may be determined by controlling the mass, volume ratio, and particle size distribution of the composite particles 10 and the conductive component 15.

In one embodiment, the conductive component may be spherical, polyhedral, flake-like, plate-like, or oval in shape.

In one embodiment, the conductive component may have an average size of 10 nm to 3 μm. Here, the size may refer to the maximum length or diameter of the conductive component. Under this condition, the conductive component may have excellent dispersibility and electrical conductivity. For example, the conductive component may have an average size of 10 nm, 50 nm, 100 nm, 200 nm, 300 nm, 400 nm, 500 nm, 600 nm, 700 nm, 800 nm, 900 nm, 1 μm, 2 μm or 3 μm.

In one embodiment, the conductive hard coating particles may have a density of 1.8 to 2.5 g/cm³. Under this condition, the negative electrode active material may have excellent structural stability and lightweight characteristics. For example, the density of the conductive hard coating particles may be 1.8 to 2.1 g/cm³.

In one embodiment, the conductive hard coating particles may have a BET specific surface area of 100 m²/g or less. Under this condition, the negative electrode active material may have excellent structural stability.

In one embodiment, the conductive hard coating particles may have an impurity content of 100 ppm or less. Under this condition, the negative electrode active material may have excellent electrical conductivity.

In one embodiment, the conductive hard coating particles may have a resistivity of 10 μΩ·m or less. Under this condition, the negative electrode active material may have excellent electrical conductivity. For example, the resistivity may be 3 to 8 μΩ·m, or 3 to 5μΩ·m.

In one embodiment, the conductive hard coating particles may have a pencil hardness of 4H or higher as measured according to ISO 15184. Under this condition, the negative electrode active material may have excellent electrical conductivity, electrical properties, and high-capacity characteristics. For example, the conductive hard coating particles may have a pencil hardness of 4H to 6H. For example, the conductive hard coating particles may have a pencil hardness of 4H, 5H or 6H.

In one embodiment, the conductive component may include graphite particles, graphene particles, and conductive hard coating particles at a weight ratio of 1:0.5 to 6:0.1 to 4. When these particles are included at a weight ratio within the above range, the negative electrode active material may have excellent electrical conductivity and capacity characteristics, as well as excellent high-output and long-life characteristics. For example, the conductive component may include graphite particles, graphene particles, and conductive hard coating particles at a weight ratio of 1:1 to 5:0.5 to 4, 1:2 to 4:1 to 4 or 1:2 to 3:2 to 4.

In one embodiment, the conductive component may be included in an amount of 1 to 30 wt % based on the total weight of the negative electrode active material. When the conductive component is included in an amount within the above range, the negative electrode active material may have excellent structural stability, electrical conductivity and high-output characteristics, may be prevented from capacity reduction, and may have excellent long-life characteristics. For example, the conductive component may be included in an amount of 1 to 25 wt %, 1 to 20 wt %, 1 to 15 wt %, 1 to 10 wt %, or 1 to 8 wt %. For example, the conductive component may be included in an amount of 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 wt %.

### Second Embodiment

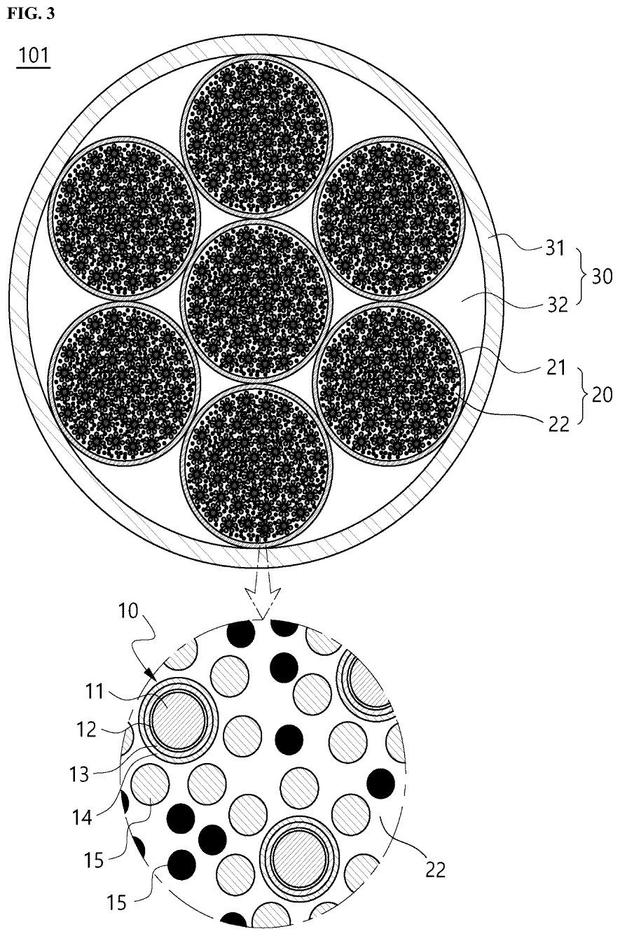

FIG. 3 illustrates a negative electrode active material according to another embodiment of the present disclosure. Referring to FIG. 3, a negative electrode active material 101 includes: a primary particle 20 including a first hollow core 21 having a first hollow portion 22 formed therein and at least one composite particle 10 packed in the first hollow portion 22; and a secondary particle 30 including a second hollow core 31 having a second hollow portion 32 formed therein and at least one primary particle 20 packed in the second hollow portion 32, wherein the composite particle 10 includes a graphite core 11, and a graphene layer 12 and a first coating layer 13 sequentially formed on the outer surface of the graphite core 11, wherein the first coating layer 13 includes a hard coating layer.

In one embodiment, the first coating layer 13, the first hollow core 21, and the second hollow core 31 each have a higher hardness than the graphite core 11 and the graphene layer 12.

Hereinafter, each component of the negative electrode active material according to the second embodiment will be described in detail.

(1) Primary particle: The primary particle 20 includes a first hollow core 21 having a first hollow portion 22 formed therein and at least one composite particle 10 packed in the first hollow portion 22.

(1-1) First hollow core: the first hollow core 21 includes a first hollow portion 22 formed therein, and a composite particle 10 is packed in a first hollow portion 22. The first hollow core 21 may be spherical or oval in shape. For example, the first hollow core 21 may be spherical in shape.

In one embodiment, the first hollow portion 22 may have an average diameter of 1.5 to 20 μm (a radius of 0.75 to 10 μm). Under this condition, the negative electrode active material may have excellent high-output and long-life characteristics while being prevented from being destroyed by volume expansion of the composite particle during charging and discharging. For example, the average diameter may be 2 to 20 μm, 3 to 20 μm, 6 to 20 μm, or 10 to 20 μm. For example, the average diameter may be 1.5, 1.6, 1.7, 1.8, 1.9, 2, 3, 4, 5, 6, 7, 8, 9, 10, 11, 12, 13, 14, 15, 16, 17, 18, 19 or 20 μm.

In one embodiment, the first hollow core 21 may have a thickness of 5 to 1,000 nm. Under this condition, the first hollow core may have excellent hardness and mechanical strength, and thus the negative electrode active material may be prevented from being broken or damaged even when the composite particle 10 expands during charging and discharging. For example, the first hollow core may have a thickness of 5 to 300 nm, 5 to 250 nm, 5 to 200 nm, 10 to 200 nm, or 10 to 50 nm.

In one embodiment, the first hollow core 21 has a higher hardness than the graphite core 11 and the graphene layer 12. Under this condition, the first hollow core 21 may have may have excellent hardness and mechanical strength, and thus the negative electrode active material may be prevented from being broken or damaged even when the composite particle 10 expands during charging and discharging.

In one embodiment, the first hollow core 21 may have a density of 1.8 to 2.5 g/cm³. Under this condition, the negative electrode active material may have excellent structural stability and lightweight characteristics. For example, the first hollow core 21 may have a density of 1.8 to 2.1 g/cm³.

In another embodiment, the first hollow core 21 may have a density of less than 1.8 g/cm³. Under this condition, the negative electrode active material may have excellent structural stability and lightweight characteristics. For example, the first hollow core may have a density of 0.3 to 1.7 g/cm³.

In one embodiment, the first hollow core 21 may have a BET specific surface area of 100 m²/g or less. Under this condition, the negative electrode active material may have excellent structural stability.

In another specific example, the first hollow core 21 may have a BET specific surface area of more than 100 m²/g. Under this condition, the negative electrode active material may have excellent structural stability. For example, the BET specific surface area may be 110 to 500 m²/g.

In one embodiment, the first hollow core 21 may have an impurity content of 100 ppm or less. Under this condition, the negative electrode active material may have excellent electrical conductivity.

In one embodiment, the first hollow core 21 may have a resistivity of 10 μΩ·m or less. Under this condition, the negative electrode active material may have excellent electrical conductivity. For example, the first hollow core 21 may have a resistivity of 5 μΩ·m or less, or 3 to 5 μΩ·m.

In one embodiment, the first hollow core 21 may have a pencil hardness of 4H or higher as measured according to ISO 15184. Under this condition, the first hollow core may have excellent durability and strength, and the effect of preventing the first hollow core (or negative electrode active material) from being broken or damaged during charging and discharging may be excellent. For example, the first hollow core 21 may have a pencil hardness of 4H to 6H. For example, the first hollow core 21 may have a pencil hardness of 4H, 5H or 6H.

In one embodiment, the first hollow core 21 may have an oxygen transmission rate of 4.0×10⁻² darcy or less, which is a constant value calculated by Darcy's law. Under this condition, the negative electrode active material may have excellent gas impermeability and excellent electrical properties and durability, and the effect of preventing the secondary battery from catching fire in a high-temperature environment may be excellent.

For example, the first hollow core may have an oxygen transmission rate of 4.0×10⁻⁵ darcy or less, or 4.0×10⁻⁸ darcy to 4.0×10⁻⁵ darcy. For example, the first hollow core may have an oxygen transmission rate of 4.0×10⁻² darcy or less, 4.0×10⁻³ darcy or less, 4.0×10⁻⁴ darcy or less, 4.0×10⁻⁵ darcy or less, 4.0×10⁻⁶ darcy or less, 4.0×10⁻⁷ darcy or less or 4.0×10⁻⁸ darcy or less.

In one embodiment, the oxygen transmission rate (OTR) may be measured by a known method according to ASTM D3985 or JIS K7126. For example, the oxygen transmission rate of the first hollow core may be measured by expressing the volume of oxygen gas, which passes through the first hollow core (first hollow portion) by differential pressure, as a function of time, and measuring the permeability coefficient and transmission rate of oxygen using the expressed volume.

For example, the oxygen transmission rate of the first hollow core may be measured using an instrument such as OX-TRAN Model 2/21 or OX-TRAN Model 2/61 commercially available from Mocon, Inc.

In one embodiment, the full width at half maximum (FWHM) of X-ray diffraction angle (2θ) for the (002) plane of the first hollow core 21, measured using CuKα radiation, may be 3° to 6°. In this FWHM range, the first hollow core may have high hardness, excellent durability and crystallinity, and excellent electrical conductivity, and thus the negative electrode active material may have high-capacity and high-output characteristics. For example, the FWHM of X-ray diffraction angle (2θ) for the first hollow core may be 3.5° to 5.8°. For example, the FWHM of the X-ray diffraction (XRD) peaks of the first hollow core, measured using CuKα radiation of wavelength 1.54178 Å at a 2θ angle of 10 to 70° with a step size of 0.01°, may be 3° to 6°. For example, the FWHM of X-ray diffraction angle (2θ) for the (002) plane of the first hollow core, measured using CuKα radiation, may be 3°, 3.1°, 3.2°, 3.3°, 3.4°, 3.5°, 3.6°, 3.7°, 3.8°, 3.9°, 4°, 4.1°, 4.2°, 4.3°, 4.4°, 4.5°, 4.6°, 4.7°, 4.8°, 4.9°, 5°, 5.1°, 5.2°, 5.3°, 5.4°, 5.5°, 5.6°, 5.7°, 5.8°, 5.9° or 6°.

In one embodiment, the X-ray diffraction peak of the first hollow core 21, measured using CuKα radiation, may satisfy the following Equation 1:

$$2 \leq I ( 002 ) / I ( 100 ) \leq 6 \qquad [ Equation 1 ]$$

wherein I(002) represents the peak intensity of the (002) plane of the first hollow core, and I(100) represents the peak intensity of the (100) plane of the first hollow core.

When the condition of Equation 1 is satisfied, the first hollow core may have high hardness, excellent durability and crystallinity, and excellent electrical conductivity, and thus the negative electrode active material may have high-capacity and high-output characteristics. For example, I(002)/I(100) in Equation 1 may be 2.5 to 5.5, 2.5 to 5, or 2 to 4.5. For example, I(002)/I(100) in Equation 1 may be 2, 2.1, 2, 2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9 or 6.

In one embodiment, the first hollow core 21 may be included in an amount of 1 to 50 wt % based on the total weight of the primary particle. When the first hollow core 21 is included in an amount within the above range, it may have excellent structural stability, miscibility, and durability, and the negative electrode active material may have excellent high-capacity and high-output characteristics. For example, the first hollow core may be included in an amount of 1 to 45 wt %, 1 to 50 wt %, 1 to 40 wt %, 1 to 30 wt %, 1 to 25 wt %, or 1 to 20 wt %. For example, the first hollow core may be included in an amount of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 wt %.

In one embodiment, the primary particle 20 may be included in an amount of 20 to 80 wt % based on the total weight of the negative electrode active material. When the primary particle 20 is included in an amount within the above range, it may have excellent structural stability, miscibility, and durability, and the negative electrode active material may have excellent high-capacity and high-output characteristics. For example, the primary particle may be included in an amount of 25 to 75 wt %, 25 to 70 wt %, 30 to 70 wt %, 30 to 65 wt %, 35 to 65 wt %, or 40 to 60 wt %. For example, the primary particle may be included in an amount of 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79 or 80 wt %.

(1-2) Composite particle: The composite particle 10 includes a graphite core 11, and a graphene layer 12 and a first coating layer 13 sequentially formed on the outer surface of the graphite core 11.

In one embodiment, the composite particle 10 may be spherical, polyhedral, oval or irregular in shape. For example, it may be spherical in shape.

In one embodiment, the composite particle 10 may have an average size of 0.5 to 23 μm. Here, the size may refer to the maximum length or diameter (size) of the composite particle 10. Under this condition, the composite particle 10 may have high-capacity and high-output characteristics, and the negative electrode active material may be prevented from being broken or destroyed by expansion of the composite particle 10, and thus may have excellent long-life characteristics. For example, the composite particle 10 may have an average size of 1 to 20 μm, 1.5 to 15 μm, 2 to 15 μm, 3 to 15 μm, 3 to 10 μm, or 3 to 8 μm. For example, the composite particle 10 may have an average size of 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22 or 23 μm.

In one embodiment, the composite particle 10 may be included in an amount of 25 to 80 wt % based on the total weight of the primary particle. When the composite particle 10 is included in an amount within the above range, the composite particle may have excellent miscibility and durability, and the negative electrode active material may have excellent high-capacity and high-output characteristics. For example, the composite particle 10 may be included in an amount of 25 to 70 wt %. As another example, the composite particle may be included in an amount of 25 to 75 wt %, 25 to 65 wt %, 25 to 60 wt %, 25 to 50 wt %, 25 to 45 wt %, or 30 to 45 wt %. For example, the composite particle may be included in an amount of 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79 or 80 wt %.

(1-3) Graphite core: The graphite core may be included to ensure high-capacity and high-output characteristics. In one embodiment, the graphite core may be spherical, polyhedral, oval or irregular in shape. For example, it may be spherical in shape.

The graphite core may include at least one of natural graphite, artificial graphite, and expandable graphite.

In one embodiment, the graphite core 11 may have an average size of 0.1 to 20 μm. Here, the size may refer to the maximum length or diameter (size) of the graphite core 11.

For example, the graphite core 11 may be flake-like, oval or spherical in shape. Under this condition, the graphite core 11 may have high-capacity and high-output characteristics, and the negative electrode active material may be prevented from being broken or destroyed by expansion of the graphite core 11, and thus may have excellent long-life characteristics. For example, the graphite core 11 may have an average size of 0.5 to 20 μm, 1 to 18 μm, 1 to 16 μm, 2 to 15 μm, 3 to 15 μm, 3 to 10 μm, or 3 to 7 μm. For example, the graphite core 11 may have an average size of 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19 or 20 μm.

In one embodiment, the graphite core 11 may exhibit relatively high crystallinity. The crystallinity may be determined by conventional X-ray diffraction (XRD) analysis. Under this condition, the graphite core 11 may have excellent durability and structural stability, and thus prevent destruction and breakage of the negative electrode active material, so that the negative electrode active material may have excellent long-life characteristics and excellent electrical conductivity, strength, and high-output characteristics.

(1-4) Graphene layer: The graphene layer 12 may be included to improve the electrical conductivity, strength, and high-output characteristics of the negative electrode active material by enhancing the electrical conductivity, durability, and structural stability.

For example, the graphene layer 12 may be formed on at least a portion of the outer surface of the graphite core 11 by milling the graphite. For example, the graphene layer 12 may be formed as a shell surrounding the outer surface of the graphite core 11.

In one embodiment, the graphene layer 12 may be formed so that the graphene layer 12 is included in an amount of 1 to 10 wt % based on the weight of the graphite core 11. When the graphene layer 12 is included in an amount within the above range, the negative electrode active material may have excellent electrical conductivity and capacity characteristics, as well as excellent high-output and long-life characteristics.

In one embodiment, the graphene layer 12 may have a thickness of 5 to 500 nm. Under this condition, the graphene layer 12 have excellent durability, structural stability, and electrical conductivity, and the negative electrode active material may have high-output characteristics. For example, the graphene layer 12 may have a thickness of 5 to 400 nm, 5 to 300 nm, 10 to 250 nm, 10 to 200 nm, 10 to 150 nm, 15 to 100 nm, or 30 to 70 nm.

The graphene layer 12 may be formed by a process including a step of separating graphite into layers while refining the graphite particles of the graphite core 11 formed of at least one of natural graphite, artificial graphite, and expandable graphite by a milling process. When the graphene layer 12 is formed under these conditions, it may have excellent crystallinity and electrical properties.

In one embodiment, the graphene layer 12 may include a layered structure consisting of 1 to 10 layers. Under this condition, the graphene layer 12 may have excellent crystallinity, and the negative electrode active material may have excellent electrical conductivity and capacity characteristics, as well as excellent high-output and long-life characteristics. For example, the graphene layer 12 may include a layered structure consisting of 2 to 8 layers or 2 to 5 layers.

In one embodiment, the X-ray diffraction (XRD) spectrum of the graphene layer 12, measured using CuKα radiation of wavelength 1.54 to 2.0 Å, may have a peak at a diffraction angle (2θ) of 25 to 28° in the (002) plane, and have a peak at a diffraction angle (2θ) of 42 to 47° in the (101) plane.

In one embodiment, the ratio of the peak intensity of the (002) plane to the peak intensity of the (101) plane in the X-ray diffraction (XRD) spectrum of the graphene layer 12 may be 50 or more. Under this condition, the graphene layer may have excellent durability, and the negative electrode active material may have excellent electrical conductivity and capacity characteristics, as well as excellent high-output and long-life characteristics. For example, the ratio of the peak intensity of the (002) plane to the peak intensity of the (101) plane in the X-ray diffraction (XRD) spectrum of the graphene layer 12, measured using CuKα radiation of wavelength 1.54 to 2.0 Å, may be 70 or more, 80 or more, 100 or more, 200 or more, 300 or more, or 50 to 10,000.

In one embodiment, the ratio of D-band peak intensity to G-band peak intensity (ID/I_{G}) in the Raman spectrum of the graphene layer 12 may be 0.65 or less. Under this condition, the graphene layer 12 may have excellent durability and electrical conductivity, and thus the negative electrode active material may have high-capacity and high-output characteristics. For example, the ratio of D-band peak intensity to G-band peak intensity (ID/I_{G}) in the Raman spectrum of the graphene layer 12 may be 0.65 or less, 0.55 or less, or 0.10 to 0.55.

For example, in the Raman spectrum of the graphene layer 12, measured under 532-nm CW laser excitation, the 1G-band peak may appear in the wavelength range of 1,560 to 1,600 cm⁻¹, and the 1D-band peak may appear in the wavelength range of 2,600 to 2,800 cm⁻¹.

In one embodiment, the ratio of 2D-band peak intensity to G (1G)-band peak intensity (I_{2D}/I_{G}) in the Raman spectrum of the graphene layer 12 may be 0.35 to 0.65. Under this condition, the graphene layer 12 may have excellent durability and electrical conductivity, and thus the negative electrode active material may have high-capacity and high-output characteristics. For example, the ratio of 2D-band peak intensity to G band peak intensity (I_{2D}/I_{G}) in the Raman spectrum of the graphene layer 12 may be 0.65 or less, or 0.35 to 0.65.

In one embodiment, in the Raman spectrum of the graphene layer 12, measured under 532-nm CW laser excitation, the Raman shift of the 2D band may have a peak in the wavelength range of 2,680 to 2,725 cm⁻¹. Under this condition, the graphene layer may have minimized electrical resistance, and the negative electrode active material may have excellent electrical conductivity and high-output characteristics, may be prevented from capacity reduction, and may have excellent long-life characteristics.

In one embodiment, the Raman spectrum of the graphene layer 12, measured under 532-nm CW laser excitation, may show the 2D-band peak in the wavenumber range of 2,660 to 2,720 cm⁻¹, the D-band peak in the wavenumber range of 1,320 to 1,370 cm⁻¹, and the G-band peak in the wavenumber range of 1,550 to 1,600 cm⁻¹. Under these conditions, the graphene layer may have minimized electrical resistance, and the negative electrode active material may have excellent electrical conductivity and high-output characteristics, may be prevented from capacity reduction, and may have excellent long-life characteristics.

Meanwhile, the Raman spectra of the graphene layer 12, measured under two CW laser excitations, that is, 532-nm excitation with a fixed laser power of 50 mW and 785-nm excitation with a fixed laser power of 20 mW, may show the 1D-band peak in the wavenumber range of 2,600 to 2,780 cm⁻¹, 1G-band peak in the wavenumber range of 1,560 to 1,600 cm⁻¹, and the 2D-band peak in the wavenumber range of 2,680 to 2,725 cm⁻¹. Under these conditions, the graphene layer may have minimized electrical resistance, and the negative electrode active material may have excellent electrical conductivity and high-output characteristics, may be prevented from capacity reduction, and may have excellent long-life characteristics.

In one embodiment, in the Raman spectrum of the graphene layer, measured under 785-nm excitation CW laser, the ratio of 1D-band peak intensity to 1G-band peak intensity (ID/I_{G}) may be 0.15 to 0.40. Under this condition, the graphene layer may have minimized electrical resistance, and the negative electrode active material may have excellent electrical conductivity and high-output characteristics, may be prevented from capacity reduction, and may have excellent long-life characteristics. For example, the ratio of 1D-band peak intensity to 1G-band peak intensity (ID/I_{G}) may be 0.25 to 0.4.

In one embodiment, the above-described properties of the graphene layer 12 may be obtained at desired values through a milling process for graphite particles.

For example, the ratio of D-band peak intensity to G-band peak intensity (ID/I_{G}) in the Raman spectra changed from 0.05 to 0.53 for natural graphite and from 0.1 to 0.53 for artificial graphite through the milling process.

(1-5) First coating layer: The first coating layer 13 is formed on the outer surface of the graphene layer 12 and includes a hard coating layer (or first hard coating layer). When the first coating layer is formed, the composite particle may have excellent structural stability, and the graphite core may be prevented from being broken or damaged during charging and discharging, and may have excellent electrical conductivity and high-output characteristics.

In one embodiment, the first coating layer may have a thickness of 300 nm to 1 μm. Under this condition, the first coating layer may have excellent hardness and mechanical strength, the graphite core may be prevented from being broken or damaged during charging and discharging, and the negative electrode active material has excellent electrical properties and high-capacity characteristics. For example, the thickness of the first coating layer may be 300 to 900 nm, 300 to 800 nm, 300 to 700 nm, 300 to 600 nm, or 300 to 500 nm.

In one embodiment, the hard coating layer may have a density of 1.8 to 2.5 g/cm³. Under this condition, the negative electrode active material may have excellent structural stability and lightweight characteristics. For example, the hard coating layer may have a density of 1.8 to 2.1 g/cm³.

In one embodiment, the hard coating layer may have a BET specific surface area of 100 m²/g or less. Under this condition, the negative electrode active material may have excellent structural stability.

In one specific example, the hard coating layer may have an impurity content of 100 ppm or less. Under this condition, the negative electrode active material may have excellent electrical conductivity.

In one embodiment, the hard coating layer may have a resistivity of 10 μΩ·m or less. Under this condition, the negative electrode active material may have excellent electrical conductivity. For example, the resistivity of the hard coating layer may be 3 to 8 μΩ·m or 3 to 5 μΩ·m.

In one embodiment, the hard coating layer may have a pencil hardness of 4H or higher as measured according to ISO 15184. Under this condition, the hard coating layer has excellent mechanical strength properties such as hardness and durability, and the graphite core may be prevented from being broken or damaged during charging and discharging while the negative electrode active material has excellent electrical properties and high-capacity characteristics. For example, the hard coating layer may have a pencil hardness of 4H to 6H. For example, the hard coating layer may have a pencil hardness of 4H, 5H or 6H.

(1-6) Second coating layer: Referring to FIG. 1, the composite particle 10 may further include a second coating layer 14 formed on the outer surface of the first coating layer 13. When the second coating layer is further formed, the composite particle may have excellent structural stability, which may prevent breakage or damage to the graphite core, and thus the negative electrode active material may be prevented from capacity reduction and have excellent long-life characteristics.

The second coating layer may include at least one of a soft coating layer, a medium coating layer, and a hard coating layer (second hard coating layer).

In one embodiment, the second coating layer may have a thickness of 5 nm to 2 μm. Under this condition, the composite particle may have excellent structural stability, which may prevent breakage or damage to the graphite core, and thus the negative electrode active material may be prevented from capacity reduction and have excellent long-life characteristics. For example, the second coating layer may have a thickness of 10 nm to 1.5 μm, 30 nm to 1 μm, 50 nm to 1 μm, 80 to 700 nm, 90 to 500 nm, or 100 to 350 nm.

(1-6A) Soft coating layer: In one embodiment, the soft coating layer may be fabricated by calcining a soft coating material. In one embodiment, the soft coating material may include at least one of pitch, coke, and carbon precursors formed from other organic materials. For example, the pitch may include at least one of pyrolysis fuel oil pitch and coal tar pitch.

In one embodiment, the soft coating layer may have a thickness of 5 to 500 nm. Under this condition, the soft coating layer may have excellent flexibility and mechanical strength, which may prevent damage to the graphite core during charging and discharging and prevent breakage or damage to the negative electrode active material. For example, the thickness of the soft coating layer may be 5 to 150 nm, 5 to 100 nm, 5 to 60 nm, 5 to 30 nm, or 5 to 20 nm.

In one embodiment, the soft coating layer may have a pencil hardness of less than 2H as measured according to ISO 15184. Under this condition, the soft coating layer may have excellent flexibility and mechanical strength, which may prevent damage to the graphite core during charging and discharging and prevent breakage or damage to the negative electrode active material. For example, the pencil hardness may be B to 1H.

In one embodiment, the soft coating layer may have a density of 1.5 g/cm³ or less. Under this condition, the negative electrode active materials may have excellent structural stability and lightweight characteristics. For example, the soft coating layer may have a density of 0.3 to 1.4 g/cm³.

In one embodiment, the soft coating layer may have a BET specific surface area of 300 m²/g or more. Under this condition, the negative electrode active materials may have excellent structural stability. For example, the BET specific surface area may be 300 to 2,500 m²/g.

In one embodiment, the soft coating layer may have an impurity content of 1,000 ppm or more. Under this condition, the negative electrode active material may have excellent electrical conductivity. For example, the impurity content may be 1,000 to 5,000 ppm.

In one embodiment, the soft coating layer may have a resistivity of 50 μΩ·m or more. Under this condition, the negative electrode active material may have excellent electrical conductivity. For example, the resistivity may be 50 to 300 μΩ·m.

(1-6B) Medium coating layer: In one embodiment, the medium coating layer may be formed by heat-treating at least one of a hydrocarbon gas and carbon black. For example, the hydrocarbon gas may include at least one of methane (CH₄), ethane (C₂H₆), propane (C₃H₈), butane (C₄H₁₀), and pentane (C₅H₁₂).

In one embodiment, the medium coating layer may be amorphous or crystalline. Under this condition, the medium coating layer may have excellent strength and durability.

In one embodiment, the medium coating layer may have a thickness of 5 to 500 nm. Under this condition, the medium coating layer may have excellent hardness, flexibility, and mechanical strength, which may prevent damage to the graphite core during charging and discharging and prevent breakage or damage to the negative electrode active material. For example, the thickness of the medium coating layer may be 5 to 300 nm, 5 to 100 nm, 5 to 80 nm, 5 to 60 nm, 5 to 30 nm, or 5 to 20 nm.

In one embodiment, the medium coating layer may have a pencil hardness ranging from 2H to lower than 4H as measured according to ISO 15184. Under this condition, the medium coating layer may prevent damage to the graphite core during charging and discharging and prevent breakage or damage to the negative electrode active material, thereby providing excellent long-life characteristics. For example, the pencil hardness may be 2H to 3.5H. For example, the pencil hardness may be 2H, 3H or 3.5H.

In one embodiment, the medium coating layer may have a density ranging from higher than 1.5 g/cm³ to 1.8 g/cm³. Under this condition, the negative electrode active material may have excellent structural stability and lightweight characteristics. For example, the medium coating layer may have a density ranging from higher than 1.5 g/cm³ to 1.7 g/cm³.

In one embodiment, the medium coating layer may have a BET specific surface area of 100 to 200 m²/g. Under this condition, the negative electrode active material may have excellent structural stability.

In one embodiment, the medium coating layer may have an impurity content of 500 ppm or less. Under this condition, the negative electrode active material may have excellent electrical conductivity.

In one embodiment, the medium coating layer may have a resistivity of 20 to 40 μm. Under this condition, the negative electrode active material may have excellent electrical conductivity.

(1-6C) Hard coating layer (second hard coating layer): When the hard coating layer is included, the composite particle may have excellent structural stability, and the graphite core may be prevented from being broken and damaged during charging and discharging and have excellent electrical conductivity and high output characteristics.

In one embodiment, the hard coating layer may have a thickness of 5 nm to 500 nm. Under this condition, the hard coating layer may have excellent hardness and mechanical strength, the graphite core may be prevented from being broken or damaged during charging and discharging while the negative electrode active material has excellent electrical properties and high-capacity characteristics. For example, the thickness of the hard coating layer may be 5 to 400 nm, 5 to 250 nm, 5 to 100 nm, 5 to 80 nm, 5 to 50 nm, or 5 to 25 nm.

In one embodiment, the hard coating layer may have a density of 1.8 to 2.5 g/cm³. Under this condition, the negative electrode active material may have excellent structural stability and lightweight characteristics. For example, the hard coating layer may have a density of 1.8 to 2.1 g/cm³.

In one embodiment, the hard coating layer may have a BET specific surface area of 100 m²/g or less. Under this condition, the negative electrode active material may have excellent structural stability.

In one embodiment, the hard coating layer may have an impurity content of 100 ppm or less. Under this condition, the negative electrode active material may have excellent electrical conductivity.

In one embodiment, the hard coating layer may have a resistivity of 10 μΩ·m or less. Under this condition, the negative electrode active material may have excellent electrical conductivity. For example, the resistivity may be 3 to 8 μΩ·m, or 3 to 5 μΩ·m.

In one embodiment, the hard coating layer may have a pencil hardness of 4H or higher as measured according to ISO 15184. Under this condition, the hard coating layer may have excellent mechanical strength properties such as hardness and durability, and the graphite core may be prevented from being broken or damaged during charging and discharging while the negative electrode active material has excellent electrical properties and high-capacity characteristics. For example, the hard coating layer may have a pencil hardness of 4H to 6H. For example, the hard coating layer may have a pencil hardness of 4H, 5H or 6H.

In one embodiment, the hard coating layer may have a higher hardness than the medium coating layer and the soft coating layer, and the medium coating layer may have a higher hardness than the soft coating layer.

In one embodiment, the second coating layer may include a soft (or medium) coating layer and a medium (or soft) coating layer sequentially formed on the outer surface of the first coating layer.

For example, the second coating layer may include the soft coating layer and the medium coating layer at a weight ratio of 1:0.5 to 1:4. When the soft coating layer and the medium coating layer are included at a weight ratio within the above range, the negative electrode active material may be prevented from being broken and destroyed, and may have excellent electrical conductivity, high-output, and long-life characteristics. For example, the soft coating layer and the medium coating layer may be included at a weight ratio of 1:1 to 1:2. For example, the soft coating layer and the medium coating layer may be included at a weight ratio of 1:0.5, 1:1, 1:1.5, 1:2, 1:2.5, 1:3, 1:3.5 or 1:4.

In another embodiment, the second coating layer may include a soft (or medium) coating layer, a medium (or soft) coating layer, and a hard coating layer (second hard coating layer) sequentially formed on the outer surface of the first coating layer.

For example, the second coating layer may include the soft coating layer, the medium coating layer, and the hard coating layer at a weight ratio of 1:0.5 to 4:0.5 to 6. When the soft coating layer, the medium coating layer, and the hard coating layer are included at a weight ratio within the above range, the graphite core may be prevented from being damaged, and at the same time, the negative electrode active material may be prevented from being broken and destroyed and may have excellent electrical conductivity, high-output, and long-life characteristics. For example, these layers may be included at a weight ratio of 1:1 to 3:1 to 5 or 1:1 to 2:1.5 to 4.

In one embodiment, the graphite core may be included in an amount of 30 to 85 wt % based on the total weight of the composite particle. When the graphite core is included in an amount within the above range, the composite particle may have excellent high-output and electrical conductivity characteristics, as well as excellent long-life characteristics. For example, the graphite core may be included in an amount of 30 to 80 wt %, 35 to 80 wt %, 35 to 70 wt %, or 35 to 60 wt %. For example, the graphite core may be included in an amount of 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79 or 80 wt %.

In one embodiment, the graphene layer may be included in an amount of 0.1 to 30 wt % based on the total weight of the composite particle. When the graphene layer is included in an amount within the above range, the composite particle may have excellent high-output and electrical conductivity characteristics, as well as excellent long-life characteristics. For example, the graphene layer may be included in an amount of 1 to 30 wt %, 1 to 20 wt %, or 3 to 15 wt %. For example, the graphene layer may be included in an amount of 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 wt %.

In one embodiment, the first coating layer may be included in an amount of 1 to 50 wt % based on the total weight of the composite particle. When the first coating layer is included in an amount within the above range, the composite particle may have excellent hardness and structural stability, the graphite core may be prevented from broken and damaged during charging and discharging, and the composite particle may have excellent high-output and electrical conductivity characteristics, as well as excellent long-life characteristics. For example, the first coating layer may be included in an amount of 1 to 45 wt %, 5 to 45 wt %, 10 to 45 wt %, 15 to 45 wt %, or 15 to 30 wt %. For example, the first coating layer may be included in an amount of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 wt %.

In one embodiment, the second coating layer may be included in an amount of 1 to 40 wt % based on the total weight of the composite particle. When the second coating layer is included in an amount within the above range, the composite particle may have excellent hardness and structural stability, the graphite core may be prevented from broken and damaged during charging and discharging, and the composite particle may have excellent high-output and electrical conductivity characteristics, as well as excellent long-life characteristics. For example, the second coating layer may be included in an amount of 1 to 35 wt %, 5 to 30 wt %, 10 to 25 wt %, 15 to 25 wt %, or 15 to 20 wt %. For example, the second coating layer may be included in an amount of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40 wt %.

(1-7) Conductive component: Referring to FIG. 3, the primary particle may further include a conductive component 15 dispersed in the first hollow portion 22, wherein the conductive component 15 may include at least one of graphite particles, graphene, and conductive hard coating particles. When the conductive component is included, the negative electrode active material may have excellent electrical conductivity and high-output characteristics, may be prevented from capacity reduction, and may have long-life characteristics.

The conductive component may enhance the conductive network inside and outside the negative electrode active material. The conductive component may act not only as an internal current collector, but also as an electrochemically active material. When the composite particle and the conductive component are packed in the first hollow portion of the primary particle, a low-resistance path may be stably formed, thereby ensuring a stable ion charging/discharging path and reducing the internal resistance (contact resistance) of the negative electrode active material.

Referring to FIG. 3, the conductive component 15 may be packed and dispersed between the composite particles 10 in the first hollow portion 22 of the primary particle to form a space, and when the composite particles 10 expand, the conductive component 15 may spatially absorb the expansion.

In one embodiment, the packing ratio may be determined by controlling the mass, volume ratio, and particle size distribution of the composite particles 10 and the conductive component 15.

In one embodiment, the conductive component may be spherical, polyhedral, flake-like, plate-like, or oval in shape.

In one embodiment, the conductive component may have an average size of 10 nm to 3 μm. Here, the size may refer to the maximum length or diameter of the conductive component. Under this condition, the conductive component may have excellent dispersibility and electrical conductivity. For example, the conductive component may have an average size of 10 nm, 50 nm, 100 nm, 200 nm, 300 nm, 400 nm, 500 nm, 600 nm, 700 nm, 800 nm, 900 nm, 1 μm, 2 μm or 3 μm.

In one embodiment, the conductive hard coating particles may have a density of 1.8 to 2.5 g/cm³. Under this condition, the negative electrode active material may have excellent structural stability and lightweight characteristics. For example, the density of the conductive hard coating particles may be 1.8 to 2.1 g/cm³.

In one embodiment, the conductive hard coating particles may have a BET specific surface area of 100 m²/g or less. Under this condition, the negative electrode active material may have excellent structural stability.

In one embodiment, the conductive hard coating particles may have an impurity content of 100 ppm or less. Under this condition, the negative electrode active material may have excellent electrical conductivity.

In one embodiment, the conductive hard coating particles may have a resistivity of 10 μΩ·m or less. Under this condition, the negative electrode active material may have excellent electrical conductivity. For example, the resistivity may be 3 to 8 μΩ·m, or 3 to 5μΩ·m.

In one embodiment, the conductive hard coating particles may have a pencil hardness of 4H or higher as measured according to ISO 15184. Under this condition, the negative electrode active material may have excellent electrical conductivity, electrical properties, and high-capacity characteristics. For example, the conductive hard coating particles may have a pencil hardness of 4H to 6H. For example, the conductive hard coating particles may have a pencil hardness of 4H, 5H or 6H.

In one embodiment, the conductive component may include graphite particles, graphene particles, and conductive hard coating particles at a weight ratio of 1:0.5 to 6:0.1 to 4. When these particles are included at a weight ratio within the above range, the negative electrode active material may have excellent electrical conductivity and capacity characteristics, as well as excellent high-output and long-life characteristics. For example, the conductive component may include graphite particles, graphene particles, and conductive hard coating particles at a weight ratio of 1:1 to 5:0.5 to 4, 1:2 to 4:1 to 4 or 1:2 to 3:2 to 4.

In one embodiment, the conductive component may be included in an amount of 1 to 30 wt % based on the total weight of the primary particle. When the conductive component is included in an amount within the above range, the negative electrode active material may have excellent structural stability, electrical conductivity and high-output characteristics, may be prevented from capacity reduction, and may have excellent long-life characteristics. For example, the conductive component may be included in an amount of 1 to 25 wt %, 1 to 20 wt %, 1 to 15 wt %, 1 to 10 wt %, or 1 to 8 wt %. For example, the conductive component may be included in an amount of 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 wt %.

(2) Secondary particle: The secondary particle 30 includes a second hollow core 31 having a second hollow portion 32 formed therein and at least one primary particle 20 packed in the second hollow portion 32.

The above secondary particle (second hollow core) may be spherical or oval in shape. For example, it may be spherical in shape.

The diameter of the second hollow portion is larger than the diameter of the first hollow portion.

In one embodiment, the second hollow portion of the second hollow core may have an average diameter of 2 to 80 μm. Under this condition, the negative electrode active material may be prevented from being destroyed during charging and discharging, and may have excellent long-life characteristics. For example, the second hollow portion may have an average diameter of 3 to 50 μm, 6 to 50 μm, 10 to 50 μm, 6 to 45 μm, or 10 to 40 μm. For example, the second hollow portion may have an average diameter of 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79 or 80 μm.

In one embodiment, the second hollow core may have a thickness of 5 to 1,000 nm. Under this condition, the second hollow core may have excellent hardness and mechanical strength, so that the negative electrode active material may be prevented from being broken or damaged during charging and discharging. For example, the thickness of the second hollow core may be 5 to 500 nm, 5 to 300 nm, 5 to 250 nm, 10 to 200 nm, or 10 to 50 nm.

In one embodiment, the second hollow core 31 has a higher hardness than the graphite core 11 and the graphene layer 12. Under this condition, the negative electrode active material may have excellent high-capacity and electrical conductivity characteristics, and have excellent hardness and structural stability, so that it may be prevented from being broken or damaged during charging and discharging.

In one embodiment, the second hollow core 31 may have a density of 1.8 to 2.5 g/cm³. Under this condition, the negative electrode active material may have excellent structural stability and lightweight characteristics. For example, the second hollow core 31 may have a density of 1.8 to 2.1 g/cm³.

In one specific example, the second hollow core 31 may have a BET specific surface area of 100 m²/g or less. Under this condition, the negative electrode active material may have excellent structural stability.

In another embodiment, the second hollow core 31 may have a BET specific surface area of more than 100 m²/g. Under this condition, the negative electrode active material may have excellent structural stability. For example, the BET specific surface area may be 110 to 500 m²/g.

In one embodiment, the second hollow core 31 may have an impurity content of 100 ppm or less. Under this condition, the negative electrode active material may have excellent electrical conductivity.

In one embodiment, the second hollow core 31 may have a resistivity of 10 μΩ·m or less. Under this condition, the negative electrode active material may have excellent electrical conductivity. For example, the second hollow core 31 may have a resistivity of 5 μΩ·m or less, or 3 to 5μΩ·m.

In one embodiment, the second hollow core 31 may have a pencil hardness of 4H or higher as measured according to ISO 15184. Under this condition, the second hollow core may have excellent durability and strength, and the effect of preventing the second hollow core (or negative electrode active material) from being broken or damaged during charging and discharging may be excellent. For example, the second hollow core 31 may have a pencil hardness of 4H to 7H. For example, the second hollow core 31 may have a pencil hardness of 4H, 5H, 6H or 7H.

In one embodiment, the second hollow core 31 may have an oxygen transmission rate of 4.0×10⁻² darcy or less, which is a constant value calculated by Darcy's law. Under this condition, the negative electrode active material may have excellent gas impermeability and excellent electrical properties and durability, and the effect of preventing the secondary battery from catching fire in a high-temperature environment may be excellent.

For example, the second hollow core may have an oxygen transmission rate of 4.0×10⁻⁵ darcy or less, or 4.0×10⁻⁸ darcy to 4.0×10⁻⁵ darcy. For example, the second hollow core may have an oxygen transmission rate of 4.0×10⁻⁵ darcy, 4.0×10⁻⁶ darcy, 4.0×10⁻⁷ darcy or 4.0×10⁻⁸ darcy.

In one embodiment, the oxygen transmission rate (OTR) may be measured by a known method according to ASTM D3985 or JIS K7126. For example, the oxygen transmission rate of the second hollow core may be measured by expressing the volume of oxygen gas, which passes through the second hollow core (second hollow portion) by differential pressure, as a function of time, and measuring the permeability coefficient and transmission rate of oxygen using the expressed volume.

For example, the oxygen transmission rate of the second hollow core may be measured using an instrument such as OX-TRAN Model 2/21 or OX-TRAN Model 2/61 commercially available from Mocon, Inc.

In one embodiment, the full width at half maximum (FWHM) of X-ray diffraction angle (2θ) for the (002) plane of the second hollow core 31, measured using CuKα radiation, may be 3° to 6°. In this FWHM range, the second hollow core may have high hardness, excellent durability and crystallinity, and excellent electrical conductivity, and thus the negative electrode active material may have high-capacity and high-output characteristics. For example, the FWHM of X-ray diffraction angle (2θ) for the second hollow core may be 3.5 to 5.8°. For example, the FWHM of the X-ray diffraction (XRD) peak of the second hollow core, measured using CuKα radiation of wavelength 1.54178 Å at a 2θ angle of 10 to 70° with a step size of 0.01°, may be 3° to 6°. For example, the FWHM of X-ray diffraction angle (2θ) for the (002) plane of the second hollow core 31, measured using CuKα radiation, may be 3°, 3.1°, 3.2°, 3.3°, 3.4°, 3.5°, 3.6°, 3.7°, 3.8°, 3.9°, 4°, 4.1°, 4.2°, 4.3°, 4.4°, 4.5°, 4.6°, 4.7°, 4.8°, 4.9°, 5°, 5.1°, 5.2°, 5.3°, 5.4°, 5.5°, 5.6°, 5.7°, 5.8°, 5.9° or 6°.

In one embodiment, the X-ray diffraction peak of the second hollow core 31, measured using CuKα radiation, may satisfy the following Equation 1:

$$2 \leq I ( 002 ) / I ( 100 ) \leq 6 \qquad [ Equation 1 ]$$

wherein I(002) represents the peak intensity of the (002) plane of the second hollow core, and I(100) represents the peak intensity of the (100) plane of the second hollow core.

When the condition of Equation 1 is satisfied, the second hollow core may have high hardness, excellent durability and crystallinity, and excellent electrical conductivity, and thus the negative electrode active material may have high-capacity and high-output characteristics. For example, I(002)/I(100) in Equation 1 may be 2.5 to 5.5, 2.5 to 5, or 2 to 4.5. For example, I(002)/I(100) in Equation 1 may be 2, 2.1, 2, 2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9 or 6.

In one embodiment, the second hollow core 31 may be included in an amount of 1 to 50 wt % based on the total weight of the negative electrode active material. When the second hollow core 31 is included in an amount within the above range, the negative electrode active material may have excellent structural stability, miscibility, and durability, as well as excellent high-capacity and high-output characteristics. For example, the second hollow core may be included in an amount of 1 to 45 wt %, 1 to 50 wt %, 1 to 40 wt %, 1 to 30 wt %, 1 to 25 wt %, or 1 to 20 wt %. For example, the second hollow core may be included in an amount of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 wt %.

In one embodiment, the negative electrode active material may include the second hollow core and the first hollow core at a weight ratio of 1:0.5 to 1:6. When the second hollow core and the first hollow core are included at a weight ratio within the above range, the negative electrode active material may have excellent durability and structural stability, as well as excellent long-life, high-output, and electrical characteristics. For example, the negative electrode active material may include the second hollow core and the first hollow core at a weight ratio of 1:1 to 1:5, 1:1.5 to 1:5, 1:2 to 1:4, or 1:2 to 1:3. For example, the negative electrode active material may include the second hollow core and the first hollow core at a weight ratio of 1:0.5, 1:1, 1:1.5, 1:2, 1:2.5, 1:3, 1:3.5, 1:4, 1:4.5, 1:5, 1:5.5 or 1:6.

(3) Conductive component: The secondary particle may further include a conductive component (not shown) dispersed in the second hollow portion 32, wherein the conductive component (not shown) may include at least one of graphite particles, graphene particles, and conductive hard coating particles. When the conductive component is included, the negative electrode active material may have excellent electrical conductivity and high-output characteristics, may be prevented from capacity reduction, and may have long-life characteristics.

The conductive component may enhance the conductive network inside and outside the negative electrode active material. The conductive component may act not only as an internal current collector, but also as an electrochemically active material. When the composite particle and the conductive component are packed in the second hollow portion, a low-resistance path may be stably formed, thereby ensuring a stable ion charging/discharging path and reducing the internal resistance (contact resistance) of the negative electrode active material.

The conductive component may be packed and dispersed between the primary particles 20 in the second hollow portion 32 to form a space, and when the primary particles 20 expand, the conductive component may spatially absorb the expansion.

In one embodiment, regarding the conductive component packed in the secondary particle, the packing ratio may be determined by controlling the mass, volume ratio, and particle size distribution of the primary particles 20 and the conductive component (not shown).

In one embodiment, the conductive component may be spherical, polyhedral, flake-like, plate-like, or oval in shape.

In one embodiment, the conductive component may have an average size of 10 nm to 3 μm. Here, the size may refer to the maximum length or diameter of the conductive component. Under this condition, the conductive component may have excellent dispersibility and electrical conductivity. For example, the conductive component may have an average size of 10 nm, 50 nm, 100 nm, 200 nm, 300 nm, 400 nm, 500 nm, 600 nm, 700 nm, 800 nm, 900 nm, 1 μm, 2 μm or 3 μm.

In one embodiment, the conductive hard coating particles may have a density of 1.8 to 2.5 g/cm³. Under this condition, the negative electrode active material may have excellent structural stability and lightweight characteristics. For example, the density of the conductive hard coating particles may be 1.8 to 2.1 g/cm³.

In one embodiment, the conductive hard coating particles may have a BET specific surface area of 100 m²/g or less. Under this condition, the negative electrode active material may have excellent structural stability.

In one embodiment, the conductive hard coating particles may have an impurity content of 100 ppm or less. Under this condition, the negative electrode active material may have excellent electrical conductivity.

In one embodiment, the conductive hard coating particles may have a resistivity of 10 μΩ·m or less. Under this condition, the negative electrode active material may have excellent electrical conductivity. For example, the resistivity may be 3 to 8 μΩ·m, or 3 to 5 μΩ·m.

In one embodiment, the conductive hard coating particles may have a pencil hardness of 4H or higher as measured according to ISO 15184. Under this condition, the negative electrode active material may have excellent electrical conductivity, electrical properties, and high-capacity characteristics. For example, the conductive hard coating particles may have a pencil hardness of 4H to 6H. For example, the conductive hard coating particles may have a pencil hardness of 4H, 5H or 6H.

In one embodiment, the conductive component may include graphite particles, graphene particles, and conductive hard coating particles at a weight ratio of 1:0.5 to 6:0.1 to 4. When these particles are included at a weight ratio within the above range, the negative electrode active material may have excellent electrical conductivity and capacity characteristics, as well as excellent high-output and long-life characteristics. For example, the conductive component may include graphite particles, graphene particles, and conductive hard coating particles at a weight ratio of 1:1 to 5:0.5 to 4, 1:2 to 4:1 to 4 or 1:2 to 3:2 to 4.

In one embodiment, the conductive component may be included in an amount of 1 to 30 wt % based on the total weight of the negative electrode active material. When the conductive component is included in an amount within the above range, the negative electrode active material may have excellent structural stability, electrical conductivity and high-output characteristics, may be prevented from capacity reduction, and may have excellent long-life characteristics. For example, the conductive component may be included in an amount of 1 to 25 wt %, 1 to 20 wt %, 1 to 15 wt %, 1 to 10 wt %, or 1 to 8 wt %. For example, the conductive component may be included in an amount of 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 wt %.

### Method for Producing Negative Electrode Active Material

Another aspect of the present disclosure relates to a method for producing the negative electrode active material.

### First Embodiment

In one embodiment, the method for producing the negative electrode active material includes steps of: (S10) producing composite particles; (S20) producing dry powder by drying a mixed slurry comprising the composite particles and a solvent; and (S30) producing a first intermediate using the dry powder and a hard coating material

In one embodiment, the first intermediate includes a first hollow core having a first hollow portion formed therein, and at least one composite particle packed in the first hollow portion, wherein the composite particle includes a graphite core, and a graphene layer and a first coating layer sequentially formed on the outer surface of the graphite core, wherein the first coating layer includes a hard coating layer, and the first coating layer and the first hollow core each have a higher hardness than the graphite core and the graphene layer.

Step (S10) of producing composite particles: This step is a step of producing composite particles. In one embodiment, this step includes steps of: (S1) preparing a first composition including graphite powder, graphene, and a hard coating material; (S2) placing the first composition in a chamber, raising the temperature inside the chamber to 500 to 1,100° C., and reducing the pressure inside the chamber to below atmospheric pressure; (S3) introducing a hydrocarbon gas and a buffer gas into the reduced-pressure chamber to contact the first composition; and (S4) performing heat treatment by gradually increasing the pressure inside the chamber while maintaining the raised temperature.

Step (S1) of preparing first composition: This step is a step of preparing a first composition including graphite powder, graphene, and a hard coating material.

In one specific example, the graphite powder may be a conventional one. Examples of the graphite powder include plate-like natural graphite, spherical artificial graphite, and expandable graphite.

In one embodiment, the graphite powder may be one subjected to a spheroidization process by mechanical milling to remove rough parts of a flake-like carbon material and smooth the particle surface.

In one embodiment, the graphite powder may include graphite spheroidized by milling or a mixture of spheroidal artificial graphite and plate-like graphite.

In one embodiment, the graphite powder may have an average size of 10 to 5,000 nm. Here, the size may refer to the maximum length or particle diameter (size) of the graphite powder. For example, the graphite powder may be flake-like or spherical in shape. For example, the graphite powder may have an average size of 50 to 5,000 nm, 100 to 5,000 nm, 300 to 5,000 nm, 500 to 5,000 nm, or 500 to 1,000 nm.

In one embodiment, the graphene may have an average size of 10 to 5,000 nm. Here, the size may refer to the maximum length or particle diameter (size) of the graphene. For example, the graphene powder may be spherical in shape. For example, the graphene may have a size of 50 to 5,000 nm, 100 to 5,000 nm, 300 to 5,000 nm, 500 to 5,000 nm, or 500 to 1,000 nm.

In one embodiment, the graphene may be formed by milling the graphite powder. For example, the graphene may be formed by a process including a step of milling the graphite powder.

The graphene may be formed by a process including a step of separating graphite into layers while refining the graphite particles of at least one of natural graphite and artificial graphite by a milling process. The milling may be performed for, for example, 20 to 80 minutes or 30 to 70 minutes. Under this condition, graphene powder may be easily formed from the graphite powder.

In one embodiment, the graphene may include a layered structure consisting of 1 to 10 layers. Under this condition, the negative electrode active material may have excellent electrical conductivity and capacity characteristics, as well as excellent high-output and long-life characteristics. For example, the graphene may include a layered structure consisting of 2 to 8 layers or 2 to 5 layers.

The hard coating material may be spherical, polyhedral, flake-like, plate-like, or oval in shape.

In one embodiment, the hard coating material may have a density of 2.5 g/cm³ or less. Under this condition, the negative electrode active material may have excellent electrical conductivity and lightweight characteristics. For example, the density may be 0.3 to 2.5 g/cm³.

In one embodiment, the hard coating material may have an impurity content of 100 ppm or less. Under this condition, the negative electrode active material may have excellent electrical conductivity.

For example, NanoMollisAdamas, product commercially available from Lemon Energy Inc., may be used as the hard coating material.

The hard coating material may be amorphous. In addition, the hard coating material is formed through self-assembly, and thus has excellent isotropy. Further, it has excellent thermal stability, and thus does not structurally change even at high temperatures (about 3,000° C.).

The hard coating material may have high gas impermeability and excellent chemical resistance and electrical conductivity. In addition, the hard coating material may be dust-free and have an impurity content of 5 ppm or less, or 2 ppm or less. Under this condition, the negative electrode active material may have excellent strength and electrical properties, as well as excellent electrical conductivity.

In one embodiment, the hard coating material may have a resistivity of 3 to 5 μΩ·m. Under this condition, the negative electrode active material may have excellent electrical conductivity.

For example, the hard coating material may have a pencil hardness of 4H to 6H as measured according to ISO 15184, a resistivity of 3 to 5μΩ·m, and a density of 1.8 to 2.5 g/cm³.

In one embodiment, the first composition may include 100 parts by weight of graphite powder, 0.1 to 30 parts by weight of graphene, and 0.1 to 20 parts by weight of the hard coating material. Under these conditions, the miscibility and dispersibility of the components of the first composition may be excellent, and composite particles may be easily formed.

For example, the graphene may be included in an amount of 0.1 to 30 parts by weight, 0.1 to 25 parts by weight, 0.1 to 15 parts by weight, 0.1 to 10 parts by weight, or 0.1 to 5 parts by weight, based on 100 parts by weight of the graphite powder. When the graphene is included in this amount, the miscibility and dispersibility of the components may be excellent, and composite particles may be easily formed. For example, the graphene may be included in an amount of 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 parts by weight, based on 100 parts by weight of the graphite powder.

For example, the hard coating material may be included in an amount of 0.1 to 20 parts by weight, 0.1 to 15 parts by weight, 0.1 to 10 parts by weight, or 0.1 to 5 parts by weight, based on 100 parts by weight of the graphite powder. When the hard coating material is included in this amount, the miscibility and dispersibility of the components may excellent, and composite particles may be easily formed. For example, the hard coating material may be included in an amount of 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19 or 20 parts by weight, based on 100 parts by weight of the graphite powder.

In one embodiment, the first composition may further include a solvent and a dispersant.

In one embodiment, the solvent may include at least one of water, ethanol, isopropyl alcohol, and potassium hydroxide (KOH). When the solvent is included, the miscibility and dispersibility of the components of the first composition may be excellent while the graphite raw material powder is not oxidized.

In one embodiment, the dispersant may include at least one of polyvinylpyrrolidone, nitrile-butadiene rubber, hydrogenated nitrile-butadiene rubber, stearic acid, palmitic acid, oleic acid, and lauric acid. As another example, the dispersant may include at least one of stearic acid, pyrolysis fuel oil pitch, coal tar pitch, coal tar, glucose, sucrose, polyimide, polyacrylic acid (PAA), and polyvinyl alcohol (PVA). When the dispersant is included, the dispersibility of the graphite powder may be excellent, so that the first composition may be easily prepared. For example, stearic acid may be included as the dispersant. For example, the dispersant may be a mixture of stearic acid and N-methylpyrrolidone (NMP).

In embodiment, the first composition may include 100 parts by weight of graphite powder, 0.1 to 50 parts by weight of graphene, 0.1 to 20 parts by weight of the hard coating agent, 5 to 1,500 parts by weight of a solvent, and 0.1 to 30 parts by weight of a dispersant. Under these conditions, the miscibility and dispersibility of the graphite powder may be excellent, and the first composition in the form of a slurry may be easily prepared. For example, the first composition may include 100 parts by weight of graphite powder, 800 to 1,000 parts by weight of a solvent, and 0.5 to 25 parts by weight of a dispersant.

For example, the first composition in the form of a slurry may be prepared by adding and mixing the dispersant to the solvent in the above-mentioned amount, then adding and mixing the graphite powder, the graphene, and the hard coating material to the mixture to obtain a dispersion, and grinding the dispersion.

In one embodiment, the grinding may be performed by milling. In one embodiment, the milling may be performed using a bead mill, a ball mill, a high-energy ball mill, a planetary mill, a stirred ball mill, a vibration mill, or the like.

For example, the ball mill may be made of a chemically inert material that does not react with the graphite powder and other components. For example, the ball mill may include zirconia (ZrO₂). In one embodiment, the ball mill may have an average particle diameter of 0.1 to 1 mm. Under these conditions, a graphite core may be easily produced.

In one embodiment, the first composition may further include a soft coating material.

When the above soft coating material is further included, a second coating layer may be further formed on the outer surface of the first coating layer of the composite particle during the heat treatment process.

In one embodiment, the soft coating material may include at least one of pitch, coke, and carbon precursors formed from other organic materials. For example, the pitch may include at least one of pyrolysis fuel oil pitch and coal tar pitch.

In one embodiment, the soft coating material may be included in an amount of 0.1 to 20 parts by weight based on 100 parts by weight of the graphite powder. When the soft coating material is included in this amount, a second coating layer may be easily formed on the outer surface of the first coating layer of the composite particle during the heat treatment process. For example, the soft coating material may be included in an amount of 0.1 to 15 parts by weight, 0.1 to 10 parts by weight, or 0.1 to 5 parts by weight. In one embodiment, the soft coating material may be included in an amount of 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19 or 20 parts by weight based on 100 parts by weight of the graphite powder.

For example, the first composition may be dried to easily control the powder sizes of the graphite core and the negative electrode active material. For example, the drying may be performed using a spray dryer or the like. For example, the drying may be performed by spray drying using a spray dryer including a one-fluid nozzle, a two-fluid nozzle, or a four-fluid nozzle.

For example, the first composition in the form of a slurry may be dried and applied in the form of mixed powder. In one embodiment, the mixed powder obtained by drying the first composition may be spherical, polyhedral or oval in shape. For example, the mixed powder may be spherical in shape.

In one specific example, the mixed powder may have an average particle diameter (or size) of 0.1 to 15 μm. Under this condition, the miscibility and moldability may be excellent.

In one embodiment, when the first composition is spray-dried using a one-fluid nozzle, the outlet temperature of the spray dryer is set to 70 to 130° C., and spray drying is performed at an air flow rate of 650 to 850 sccm. In this case, the mixed powder obtained by spray drying may have an average particle diameter of 7 to 14 μm. In another embodiment, when the slurry may be spray-dried using a four-fluid nozzle, the mixed powder may have an average particle diameter of 0.1 to 8 μm.

Step (S2) of raising the temperature and reducing the pressure inside the chamber: This step is a step of placing the first composition in a chamber, raising the temperature inside the chamber to 500 to 1,100° C., and reducing the pressure inside the chamber to below atmospheric pressure.

The temperature inside the chamber may be raised to 500 to 1100° C. When the temperature is raised under this condition, composite particles may be easily formed from the first composition, and it is possible to prevent a phenomenon in which the graphene layer and the first coating layer are formed thicker than necessary and thus the resistance value increases, thereby preventing the movement of lithium ions from decreasing or the lithium storage space of graphite from decreasing. In addition, it is possible to prevent carbon precursor gas consumption and energy consumption from increasing, thereby economic efficiency.

In one embodiment, the heat treatment of the first composition may be performed under a vacuum below atmospheric pressure. Under this condition, the hydrocarbon gas may be uniformly diffused between the graphite cores, and a graphene layer and a first coating layer may be formed during the heat treatment. For example, the pressure inside the chamber may be reduced to a vacuum of 10⁻¹ to 10⁻⁶ Torr. For example, the pressure inside the chamber may be reduced to a vacuum of 10⁻¹ Torr, 10⁻² Torr, 10⁻³ Torr, 10⁻⁴ Torr, 10⁻⁵ Torr or 10⁻⁶ Torr.

Step (S3) of introducing hydrocarbon and buffer gas: This step is a step of introducing a hydrocarbon gas and a buffer gas into the chamber whose temperature has been raised and pressure has been reduced to contact the first composition.

In one embodiment, the buffer gas may include nitrogen (N₂) gas. When the buffer gas is introduced, the buffer gas and the hydrocarbon gas may easily penetrate between the graphite cores placed in the reduced-pressure chamber, so that the first coating layer may be formed homogeneously. In particular, the hydrocarbon gas may easily penetrate between a plurality of graphite cores, so that the first coating layer may have excellent homogeneity and be formed to have a uniform thickness.

Step (S4) of increasing pressure and performing heat treatment: This step is a step of performing heat treatment by gradually increasing the pressure inside the chamber while maintaining the raised temperature, thereby producing composite particles.

In one embodiment, the composite particles may be produced by placing the first composition in a chamber, raising the temperature inside the chamber and reducing the pressure inside the chamber, introducing a hydrogen gas and a buffer gas into the chamber, and then gradually increasing the pressure inside the reduced-pressure chamber while maintaining the raised temperature, thereby forming a first coating layer on the outer surface of the graphite core. For example, the composite particles may be produced by gradually increasing the pressure inside the chamber to 10 to 10⁵ Torr. For example, the composite particles may be produced by gradually increasing the pressure inside the chamber to 10 Torr, 10² Torr, 10³ Torr, 10⁴ Torr or 10⁵ Torr.

In one embodiment, the composite particle includes a graphite core, and a graphene layer and a first coating layer sequentially formed on an outer surface of the graphite core, wherein the first coating layer includes a hard coating layer.

The graphite core, graphene layer and first coating layer of the composite particle may be the same as described above.

In another embodiment, the composite particle may further include a second coating layer formed on the outer surface of the first coating layer. When the second coating layer is further formed, the structural stability of the composite particle may be excellent, which prevents breakage or damage to the graphite core, and thus the negative electrode active material may be prevented from capacity reduction and have excellent long-life characteristics.

The second coating layer may include at least one of a soft coating layer, a medium coating layer, and a hard coating layer (second hard coating layer).

The second coating layer may be the same as described above.

In one embodiment, the second coating layer may have a thickness of 5 nm to 2 μm. Under this condition, the structural stability of the composite particle may be excellent, which prevents breakage or damage to the graphite core, and thus the negative electrode active material may be prevented from capacity reduction and have excellent long-life characteristics. For example, the second coating layer may have a thickness of 10 nm to 1.5 μm, 30 nm to 1 μm, 50 nm to 1 μm, 80 to 700 nm, 90 to 500 nm, or 100 to 350 nm.

Step (S20) of producing dry powder: This step is a step of producing dry powder by drying a mixed slurry comprising the complex particles and a solvent.

In one embodiment, the solvent may include at least one of water, an ethanol-based solvent, an amide-based solvent, an ester-based solvent, and a hydrocarbon-based solvent. When the solvent is included, miscibility and workability may be excellent. The alcohol-based solvent may include at least one of methanol, ethanol, isopropanol, and butanol. The amide-based solvent may include at least one of N-methyl-2-pyrrolidone (NMP), dimethylacetamide (DMAC), and dimethylformamide (DMF). The hydrocarbon-based solvent may include at least one of toluene and xylene.

In one embodiment, the composite particles may be included in an amount of 25 to 95 wt % based on the total weight of the mixed slurry. Under this condition, the composite particles have excellent miscibility and dispersibility, so that a negative electrode active material having a uniform size may be produced. For example, the composite particles may be included in an amount of 30 to 85 wt %, 35 to 80 wt %, 35 to 70 wt %, 35 to 60 wt %, 40 to 50 wt % or 45 to 50 wt %.

In one embodiment, the solvent may be included in an amount of 5 to 75 wt % based on the total weight of the mixed slurry. Under this condition, the composite particles may have excellent miscibility and dispersibility. For example, the solvent may be included in an amount of 10 to 70 wt %, 10 to 65 wt %, 15 to 60 wt %, 15 to 50 wt %, 20 to 50 wt %, or 25 to 50 wt %.

The powder size of the negative electrode active material may be easily controlled by drying the mixed slurry. For example, the drying may be performed using a spray dryer or the like. For example, the drying may be performed using a spray dryer including a one-fluid nozzle, a two-fluid nozzle, or a four-fluid nozzle.

In one embodiment example, the dry powder may be spherical, polyhedral or oval in shape. For example, it may be spherical in shape.

Step (S30) of producing a first intermediate: This step is a step of producing a first intermediate using the dry powder and a hard coating material. In one embodiment, the first intermediate may be produced by mixing and calcining the dry powder and the hard coating material.

The first intermediate including a first hollow core is formed from the hard coating material, and may have excellent hardness and strength, so that the negative electrode active material may be prevented from being destroyed by expansion of the composite particle while having excellent electrical properties.

In one embodiment, the hard coating material may have a pencil hardness of 4H or higher as measured according to ISO 15184. Under this condition, the negative electrode active material may be prevented from being destroyed by expansion of the composite particle while having excellent electrical properties. For example, the hard coating material may have a pencil hardness of 4H to 6H. For example, the hard coating material may have a pencil hardness of 4H, 5H or 6H.

For example, NanoMollisAdamas, a product commercially available from Lemon Energy Inc., may be used as the hard coating material.

The hard coating material may be amorphous. In addition, the hard coating material is formed through self-assembly, and thus has excellent isotropy. Further, it has excellent thermal stability, and thus does not structurally change even at high temperatures (about 3,000° C.).

The hard coating material may have high gas impermeability and excellent chemical resistance and electrical conductivity. In addition, the hard coating material may be dust-free and have an impurity content of 5 ppm or less, or 2 ppm or less. Under this condition, the negative electrode active material may have excellent strength and electrical properties, as well as excellent electrical conductivity.

In one embodiment, the hard coating material may have a resistivity of 3 to 5 μΩ·m. Under this condition, the negative electrode active material may have excellent electrical conductivity.

In one embodiment, the hard coating material may have an average particle diameter (D50) of 3 nm to 2.5 μm. Under this condition, the first intermediate may be easily formed. For example, the average particle diameter may be 5 to 500 nm, 10 to 500 nm, or 15 to 200 nm.

In one embodiment, the calcination may be performed at 900 to 1,050° C. Under this condition, the first intermediate may be easily formed. For example, the calcination may be performed at 965 to 1,000° C.

For example, the calcination may be performed in an inert gas atmosphere. The inert gas may include nitrogen.

For example, the calcined product may be subjected to a general dry milling process using an attrition mill, an air classifier mill (ACM), a jet mill, and a pin mill, followed by classification, thereby producing the first intermediate.

In one embodiment, the first intermediate includes a first hollow core having a first hollow portion formed therein and at least one composite particle packed in the first hollow portion, wherein the composite particle includes a graphite core, and a graphene layer and a first coating layer sequentially formed on an outer surface of the graphite core, wherein the first coating layer includes a hard coating layer, and the first coating layer and the first hollow core each have a hardness higher than the graphite core and the graphene layer.

### Second Embodiment

In another embodiment of the present disclosure, a method for producing the negative electrode active material includes steps of: (S11) producing composite particles; (S21) producing dry powder by drying a mixed slurry comprising the composite particles and a solvent; and (S31) producing a second intermediate using the dry powder and a hard coating material

The second intermediate includes a primary particle including a first hollow core having a first hollow portion formed therein and at least one composite particle packed in the first hollow portion, and a secondary particle including a second hollow core having a second hollow portion formed therein and at least one primary particle packed in the second hollow portion.

The composite particle includes a graphite core, and a graphene layer and a first coating layer sequentially formed on the outer surface of the graphite core, wherein the first coating layer includes a hard coating layer, and the first coating layer, the first hollow core, and the second hollow core each have a higher hardness than the graphite core and the graphene layer.

Step (S11) of producing composite particles: This step is a step of producing composite particles. In one embodiment, this step (S11) includes steps of: (S1) preparing a first composition including graphite powder, graphene, and a hard coating material; (S2) placing the first composition in a chamber, raising the temperature inside the chamber to 500 to 1,100° C., and reducing the pressure inside the chamber to below atmospheric pressure; (S3) introducing a hydrocarbon gas and a buffer gas into the reduced-pressure chamber to contact the first composition; and (S4) performing heat treatment by gradually increasing the pressure inside the chamber while maintaining the raised temperature.

Steps (S1) to (S4) of producing the composite particles are the same as those described above with respect to the first embodiment, and this detailed description thereof will be omitted.

In one embodiment, the composite particle includes a graphite core, and a graphene layer and a first coating layer sequentially formed on an outer surface of the graphite core, wherein the first coating layer includes a hard coating layer.

The graphite core, graphene layer and first coating layer of the composite particle may be the same as described above.

In another embodiment, the composite particle may further include a second coating layer formed on the outer surface of the first coating layer. When the second coating layer is further formed, the structural stability of the composite particle may be excellent, which prevents breakage or damage to the graphite core, and thus the negative electrode active material may be prevented from capacity reduction and have excellent long-life characteristics.

The second coating layer may include at least one of a soft coating layer, a medium coating layer, and a hard coating layer (second hard coating layer).

The second coating layer may be the same as described above.

In one embodiment, the second coating layer may have a thickness of 5 nm to 2 μm. Under this condition, the structural stability of the composite particle may be excellent, which prevents breakage or damage to the graphite core, and thus the negative electrode active material may be prevented from capacity reduction and have excellent long-life characteristics. For example, the second coating layer may have a thickness of 10 nm to 1.5 μm, 30 nm to 1 μm, 50 nm to 1 μm, 80 to 700 nm, 90 to 500 nm, or 100 to 350 nm.

Step (S21) of producing dry powder: This step is a step of producing dry powder by drying a mixed slurry comprising the complex particles and a solvent.

In one embodiment, the solvent may include at least one of water, an ethanol-based solvent, an amide-based solvent, an ester-based solvent, and a hydrocarbon-based solvent. When the solvent is included, miscibility and workability may be excellent. The alcohol-based solvent may include at least one of methanol, ethanol, isopropanol, and butanol. The amide-based solvent may include at least one of N-methyl-2-pyrrolidone (NMP), dimethylacetamide (DMAC), and dimethylformamide (DMF). The hydrocarbon-based solvent may include at least one of toluene and xylene.

In one embodiment, the composite particles may be included in an amount of 25 to 95 wt % based on the total weight of the mixed slurry. Under this condition, the composite particles have excellent miscibility and dispersibility, so that a negative electrode active material having a uniform size may be produced. For example, the composite particles may be included in an amount of 30 to 85 wt %, 35 to 80 wt %, 35 to 70 wt %, 35 to 60 wt %, 40 to 50 wt % or 45 to 50 wt %.

In one embodiment, the solvent may be included in an amount of 5 to 75 wt % based on the total weight of the mixed slurry. Under this condition, the composite particles may have excellent miscibility and dispersibility. For example, the solvent may be included in an amount of 10 to 70 wt %, 10 to 65 wt %, 15 to 60 wt %, 15 to 50 wt %, 20 to 50 wt %, or 25 to 50 wt %.

The powder size of the negative electrode active material may be easily controlled by drying the mixed slurry. For example, the drying may be performed using a spray dryer or the like. For example, the drying may be performed by spray drying using a spray dryer including a one-fluid nozzle, a two-fluid nozzle, or a four-fluid nozzle.

In one embodiment example, the dry powder may be spherical, polyhedral or oval in shape. For example, it may be spherical in shape.

Step (S31) of producing a second intermediate: This step is a step of producing a second intermediate using the dry powder and a hard coating material. In one embodiment, the second intermediate may be produced by mixing and calcining the dry powder and the hard coating material.

The second intermediate including the primary particle including the first hollow core and the second hollow core packed with the primary particle is formed from the hard coating material, and may have excellent hardness and strength, so that the negative electrode active material may be prevented from being destroyed by expansion of the composite particle while having excellent electrical properties.

In one embodiment, the hard coating material may have a pencil hardness of 4H or higher as measured according to ISO 15184. Under this condition, the negative electrode active material may be prevented from being destroyed by expansion of the composite particle while having excellent electrical properties. For example, the hard coating material may have a pencil hardness of 4H to 6H. For example, the hard coating material may have a pencil hardness of 4H, 4H or 6H.

For example, NanoMollisAdamas, a product commercially available from Lemon Energy Inc., may be used as the hard coating material.

The hard coating material may be amorphous. In addition, the hard coating material is formed through self-assembly and has excellent isotropy. Further, it has excellent thermal stability, and thus does not structurally change even at high temperatures (about 3,000° C.).

The hard coating material may have high gas impermeability and excellent chemical resistance and electrical conductivity. In addition, the hard coating material may be dust-free and have an impurity content of 5 ppm or less, or 2 ppm or less. Under this condition, the negative electrode active material may have excellent strength and electrical properties, as well as excellent electrical conductivity.

In one embodiment, the hard coating material may have a resistivity of 3 to 5 μΩ·m. Under this condition, the negative electrode active material may have excellent electrical conductivity.

In one embodiment, the hard coating material may have an average particle diameter (D50) of 3 nm to 2.5 μm. Under this condition, the second intermediate may be easily formed. For example, the average particle diameter may be 5 to 500 nm, 10 to 500 nm, or 15 to 200 nm.

In one embodiment, the second intermediate may further include a soft coating material. In one embodiment, the soft coating material may include at least one of pitch, coke, and carbon precursors formed from other organic materials. For example, the pitch may include at least one of pyrolysis fuel oil pitch and coal tar pitch. When the soft coating material is further included, the second intermediate may be easily formed.

In one embodiment, the second intermediate may be produced by mixing and calcining 100 parts by weight of the dry powder, 0.1 to 30 parts by weight of the hard coating material, and 0.1 to 20 parts by weight of the soft coating material. When these components are included in these amounts, the second intermediate may be easily formed during the calcination process.

In one embodiment, the calcination may be performed at 900 to 1,200° C. Under this condition, the second intermediate may be easily formed. For example, the calcination may be performed at 965 to 1,150° C.

For example, the calcination may be performed in an inert gas atmosphere. The inert gas may include nitrogen.

For example, the calcined product may be subjected to a general dry milling process using an attrition mill, an air classifier mill (ACM), a jet mill, and a pin mill, followed by classification, thereby producing the second intermediate.

The second intermediate includes a primary particle including a first hollow core having a first hollow portion formed therein and at least one composite particle packed in the first hollow portion, and a secondary particle including a second hollow core having a second hollow portion formed therein and at least one primary particle packed in the second hollow portion.

The composite particle includes a graphite core, and a graphene layer and a first coating layer sequentially formed on an outer surface of the graphite core, wherein the first coating layer includes a hard coating layer, and the first coating layer, the first hollow core, and the second hollow core each have a higher hardness than the graphite core and the graphene layer.

### Secondary Battery Including Negative Electrode Active Material

Another aspect of the present disclosure relates to a secondary battery including the negative electrode active material. In one embodiment, the secondary battery includes: a positive electrode; a negative electrode; and an electrolyte formed between the positive electrode and the negative electrode, wherein the negative electrode includes the negative electrode active material.

The secondary battery may include a lithium secondary battery. In one embodiment, the lithium secondary battery may include: a positive electrode including a positive electrode active material; a negative electrode spaced apart from the positive electrode and including the negative electrode active material; an electrolyte interposed between the positive electrode and the negative electrode; and a separator interposed between the positive electrode and the negative electrode and configured to prevent an electrical short-circuit between the positive electrode and the negative electrode.

In one embodiment, each of the positive and negative electrodes may be fabricated by applying a mixture including an active material, a conductive material, and a binder to one surface of an electrode plate (current collector), followed by drying and pressing.

In one embodiment, the positive electrode plate and the negative electrode plate may each include at least one of copper, stainless steel, aluminum, nickel, and titanium.

As another example, the negative electrode plate may be nickel foam, copper foam, a polyimide film coated with a conductive metal, or any combination thereof.

As another example, the positive electrode plate may include a copper foil, a carbon-coated copper foil, a copper foil having a surface roughness of 5 nm or more, a nickel foil, a stainless steel foil, a nickel-coated iron (Fe) foil, a copper foil having holes formed therein with a size of 1 to 50 μm, or the like.

In one embodiment, the positive electrode active material may include a composite oxide of a metal and lithium. The metal may include at least one of cobalt (Co), manganese (Mn), aluminum (Al), and nickel (Ni). For example, the composite oxide may include at least one of lithium-nickel oxide, lithium-nickel-cobalt oxide, lithium-nickel-cobalt-manganese oxide, and lithium-nickel-cobalt-aluminum oxide.

In one embodiment, the conductive material may include at least one of natural graphite, artificial graphite, carbon black, acetylene black, Ketjen black, channel black, carbon fiber, metal fiber, fluorinated carbon, aluminum, nickel powder, zinc oxide, potassium titanate, titanium oxide, and polyphenylene-based compounds.

In one embodiment, the binder may include at least one of polyvinylidene fluoride, polyvinyl alcohol, carboxymethyl cellulose (CMC), starch, hydroxypropyl cellulose, polyvinyl pyrrolidone, polytetrafluoroethylene, polyethylene, polypropylene, ethylene-propylene-diene monomer (EPDM), styrene-based rubber, and fluorine-based rubber.

In one embodiment, the separator may be a conventional one. For example, the separator may include at least one of polyester, polyethylene, polypropylene, and polytetrafluoroethylene (PTFE). The separator may be in the form of a nonwoven fabric or a woven fabric. The separator is porous with an average pore diameter of 0.01 to 10 μm, and the separator may have a thickness of 5 to 500 μm.

In one embodiment, the electrolyte may include a non-aqueous organic solvent and a lithium salt. For example, the non-aqueous organic solvent may include at least one of a carbonate-based solvent, an ester-based solvent, an ether-based solvent, and a ketone-based solvent. The carbonate-based solvent may include at least one of dimethyl carbonate (DMC), diethyl carbonate (DEC), dipropyl carbonate (DPC), methylpropyl carbonate (MPC), ethylmethyl carbonate (EMC), ethylpropyl carbonate (EPC), ethylene carbonate (EC), propylene carbonate (PC), and butylene carbonate (BC).

The ester-based solvent may include at least one of butyrolactone, decanolide, valerolactone, caprolactone, n-methyl acetate, n-ethyl acetate, and n-propyl acetate. The ether-based solvent may include dibutyl ether or the like. The ketone-based solvent may include polymethylvinyl ketone.

The lithium salt may act as a lithium-ion source in the battery. For example, the lithium salt may include at least one of LiPF₆, LiBF₄, LiSbF₆, LiAsF₆, LiClO₄, LiCF₃SO₃, LiN(CF₃SO₂)₂, LiN(C₂F₅SO₂)₂, LiAlO₄, and LiAlCl₄, without being limited thereto.

In one embodiment, the electrolyte may further include at least one of vinylene carbonate, vinyl ethylene carbonate, monofluoroethylene carbonate, difluoroethylene carbonate, succinic anhydride, and 1,3-propane sultone.

In one embodiment, the lithium secondary battery may include a prismatic battery, a cylindrical battery, or a pouch-type battery.

Hereinafter, the configuration and effects of the present disclosure will be described in more detail by way of preferred examples of the present disclosure. However, these examples are presented as preferred examples of the present disclosure and may not be construed as limiting the present disclosure in any way. The contents not described herein may be sufficiently technically inferred by those skilled in the art, and thus the description thereof will be omitted.

### EXAMPLES AND COMPARATIVE EXAMPLES

### Example 1

(1) Production of composite particles: Graphene having a 2- to 5-layered structure was produced by mechanically milling spherical artificial graphite powder using a Gyro mixer milling machine (KM Tech Co., Ltd.) with zirconia balls at 50 to 100 rpm for 60 minutes to remove rough parts of the graphite.

Then, a first composition was prepared by mixing 100 parts by weight of graphite powder (spherical artificial graphite), 1 to 10 parts by weight of the produced graphene, 3 to 10 parts by weight of a hard coating material (carbon-based material (NanoMollisAdamas, a product commercially available from Lemon Energy Inc.) having an average particle diameter (D50) of 0.01 to 0.5 μm and a pencil hardness of 4 to 6H as measured according to ISO 15184), 100 to 250 parts by weight of a solvent, and 1 to 5 parts by weight of a dispersant according to a known method.

Then, the first composition was placed in a chamber, the temperature inside the chamber was raised to 500 to 1,100° C., and the pressure inside the chamber was reduced to 10-2 to 10-6 Torr. Then, hydrocarbon (CH₄) gas and buffer gas (nitrogen (N₂) gas) were introduced into the reduced-pressure chamber and brought into contact with the first composition. Then, heat treatment was performed by gradually increasing the pressure inside the reduced-pressure chamber to 10² to 10³ Torr while maintaining the raised temperature, thereby producing composite particles.

The composite particle included a graphite core (average particle diameter: 1 μm, pencil hardness: B to 1H as measured according to ISO 15184), and a graphene layer (thickness: 10 to 30 nm, pencil hardness: B to 2H as measured according to ISO 15184, electrical conductivity: 5 to 30 μΩ·m, and density: 0.5 to 1.5 g/cm³) and a first coating layer (hard coating layer having a thickness of 15 to 30 nm, a pencil hardness of 4H to 6H measured according to ISO 15184, and a density of 1.85 to 2.5 g/cm³) sequentially formed on the outer surface of the graphite core.

(2) Production of negative electrode active material: Dry powder was produced by drying a mixed slurry containing 100 parts by weight of the composite particles, 0.1 parts by weight of a dispersant (stearic acid), and 900 parts by weight of a solvent (ethanol) using a rotary spray dryer at a disk rotation speed of 20,000 to 30,000 rpm.

Next, a first intermediate (negative electrode active material) was produced by calcining the dry powder and a hard coating material (carbon-based material (NanoMollisAdamas, a product commercially available from Lemon Energy Inc.) with an average particle diameter (D50) of 0.01 to 0.5 μm and a pencil hardness of 4H to 6H as measured according to ISO 15184) at 900 to 1,050° C. in an inert gas atmosphere.

The first intermediate included a first hollow core (thickness: 20 to 30 nm, pencil hardness: 4H to 6H as measured according to ISO 15184, resistivity: 1 to 5 μΩ·m, and density: 1.8 to 2.3 g/cm³) having a first hollow portion (average diameter: 5 μm) formed therein, and at least one composite particle packed in the first hollow portion, wherein the first coating layer and the first hollow core each had a higher hardness than the graphite core and the graphene layer.

The negative electrode active material included 65 to 90 wt % of the composite particle and 10 to 35 wt % of the first hollow core, wherein the composite particle included 60 to 75 wt % of the graphite core, 5 to 15 wt % of the graphene layer, and 25 to 35 wt % of the first coating layer.

### Example 2

(1) Production of composite particles: Graphene having a 2- to 5-layered structure was produced by mechanically milling spherical artificial graphite powder using a Gyro mixer milling machine (KM Tech Co., Ltd.) with zirconia balls at 50 to 100 rpm for 60 minutes to remove rough parts of the graphite.

Then, a first composition was prepared by mixing 100 parts by weight of graphite powder (spherical artificial graphite), 1 to 10 parts by weight of the produced graphene, 1 to 10 parts by weight of a soft coating material (including pitch with an average particle size (D50) of 0.03 to 5 μm), 3 to 10 parts by weight of a hard coating material (carbon-based material (NanoMollisAdamas, a product commercially available from Lemon Energy Inc.) having an average particle diameter (D50) of 0.01 to 0.5 μm and a pencil hardness of 4H to 6H as measured according to ISO 15184), 100 to 250 parts by weight of a solvent, and 1 to 5 parts by weight of a dispersant according to a known method.

Then, the first composition was placed in a chamber, the temperature inside the chamber was raised to 500 to 1,100° C., and the pressure inside the chamber was reduced to 10-2 to 10-6 Torr. Then, hydrocarbon (CH₄) gas and buffer gas (nitrogen (N₂) gas) were introduced into the reduced-pressure chamber and brought into contact with the first composition. Then, heat treatment was performed by gradually increasing the pressure inside the reduced-pressure chamber to 10² to 10³ Torr while maintaining the raised temperature, thereby producing composite particles.

The composite particle included a graphite core (average particle size: 1.5 μm, pencil hardness: B to 1H as measured according to ISO 15184), and a graphene layer (thickness: 10 to 30 nm, pencil hardness: B to 2H as measured according to ISO 15184, electrical conductivity: 5 to 30μΩ·m, and density: 0.5 to 1.5 g/cm³), a first coating layer (hard coating layer having a thickness of 15 to 30 nm, a pencil hardness of 4H to 6H measured according to ISO 15184, and a density of 1.85 to 2.5 g/cm³) and a second coating layer (soft coating layer having a thickness of 10 to 20 nm, a pencil hardness of B as measured according to ISO 15184, and a density of 1.5 g/cm³) sequentially formed on the outer surface of the graphite core.

(2) Production of negative electrode active material: A first intermediate (negative electrode active material) was produced in the same manner as in Example 1, except that the composite particles produced in Example 2(1) were applied.

The first intermediate included a first hollow core (thickness: 20 to 30 nm, pencil hardness: 4H to 6H as measured according to ISO 15184, resistivity: 1 to 5 μΩ·m, and density: 1.8 to 2.3 g/cm³) having a first hollow portion (average diameter: 5 μm) formed therein, and at least one composite particle packed in the first hollow portion, wherein the first coating layer and the first hollow core each had a higher hardness than the graphite core and the graphene layer.

### Example 3

Dry powder was produced by drying a mixed slurry containing 100 parts by weight of the composite particles produced in Example 1, 0.1 parts by weight of a dispersant (stearic acid), and 900 parts by weight of a solvent (ethanol) using a rotary spray dryer at a disk rotation speed of 20,000 to 30,000 rpm.

Next, a second intermediate (negative electrode active material) was produced by calcining the dry powder and a hard coating material (carbon-based material (NanoMollisAdamas, a product commercially available from Lemon Energy Inc.) with an average particle diameter (D50) of 0.01 to 0.5 μm and a pencil hardness of 4H to 6H as measured according to ISO 15184) at 950 to 1,100° C. in an inert gas atmosphere.

The second intermediate included a primary particle including a first hollow core (thickness: 20 to 30 nm, pencil hardness: 4H to 6H as measured according to ISO 15184, resistivity: 1 to 5 μΩ·m, and density: 1.8 to 2.3 g/cm³) having a first hollow portion (average diameter: 3 μm) formed therein and at least one composite particle packed in the first hollow portion, and a secondary particle including a second hollow core (thickness: 20 to 30 nm, pencil strength: 5H to 7H as measured according to ISO 15184, resistivity: 1 to 5 μΩ·m, and density: 1.8 to 2.3 g/cm³) having a second hollow portion (average diameter: 20 μm) formed therein and at least one primary particle packed in the second hollow portion.

The composite particle included a graphite core (average particle size: 1 μm, pencil hardness: B to 1H as measured according to ISO 15184), and a graphene layer (thickness: 10 to 30 nm, pencil hardness: B to 2H as measured according to ISO 15184, electrical conductivity: 5 to 30 μ2·m, and density: 0.5 to 1.5 g/cm³) and a first coating layer (hard coating layer having a thickness of 15 to 30 nm, a pencil hardness of 4H to 6H measured according to ISO 15184, and a density of 1.85 to 2.5 g/cm³) sequentially formed on the outer surface of the graphite core, wherein the first coating layer, the first hollow core, and the second hollow core each had a higher hardness than the graphite core and the graphene layer.

### Comparative Example 1

A negative electrode active material (first intermediate) was produced in the same manner as in Example 1, except that a first hollow core was formed on the outer surface of the composite particle, produced in Example 1, using pitch carbon.

The first intermediate included a first hollow core (thickness: 20 to 30 nm, a pencil hardness of B to 1H as measured according to ISO 15184, resistivity: 20 to 30 μΩ·m, and density: 1.2 to 1.5 g/cm³) having a first hollow portion (average diameter: 5 μm) formed therein and at least one composite particle packed in the first hollow portion.

The composite particle included a graphite core (average particle diameter: 1 μm, pencil hardness: B to 1H as measured according to ISO 15184), and a graphene layer (thickness: 10 to 30 nm, pencil hardness: B to 2H as measured according to ISO 15184, electrical conductivity: 5 to 30 μΩ·m, and density: 0.5 to 1.5 g/cm³) and a first coating layer (hard coating layer having a thickness of 15 to 30 nm, a pencil hardness of 4H to 6H measured according to ISO 15184, and a density of 1.85 to 2.5 g/cm³) sequentially formed on the outer surface of the graphite core.

### Experimental Examples

(1) Measurement of oxygen transmission rate: The oxygen transmission rate of the hard coating material used in Examples 1 to 3 was measured according to ASTM D3985 using a measurement instrument (OX-TRAN model 2/21, manufactured by MOCON).

Specifically, by applying the hard coating material used in Examples 1 to 3 to the surface of a substrate (graphite having a porosity of 5 to 10%) under the same calcination conditions as those for the first intermediate (or second intermediate), each circular sample (diameter: 50 mm, thickness: 1 mm or less) was prepared in which a hard coating layer having the thickness shown in Table 1 below was formed on the surface of the substrate. Table 1 below shows the results of measuring the oxygen transmission rates of the circular samples of Examples 1 to 3. Meanwhile, the result for the control example in Table 1 is the result of measuring the oxygen transmission rate of the graphite substrate on which no hard coating layer was formed.

TABLE 1

| | Hard | Oxygen |
|---|---|---|
| | coating layer | transmission |
| | thickness | rate |
| | (nm) | (darcy's) |
| Example 1 | 50 | 0.004 |
| Example 2 | 100 | 0.0009 |
| Example 3 | 300 | 0.0006 |
| Control Example | 0 | 3 |

Referring to the results in Table 1 above, it could be seen that the coating layers of Examples 1 to 3 had an oxygen transmission rate of 0.04 darcy or less and had excellent oxygen barrier properties, indicating that these coating layers have an excellent effect of preventing breakage or damage to the first hollow core (or negative electrode active material) from occurring during secondary battery operation.

(2) Raman spectral analysis of graphene: The graphite of Example 1 (before milling) and the graphene formed by milling the graphite (after milling) were analyzed by Raman spectroscopy, and the results are shown in Tables 2 and 3 below. Raman spectra were acquired using a Thermo Scientific DXR Raman microscope at laser wavelengths of 532 nm and 785 nm.

Meanwhile, the Raman spectra of the graphene formed in Example 1 were measured under two CW laser excitations, that is, 532-nm excitation with a fixed laser power of 50 mW and 785-nm excitation with a fixed laser power of 20 mW, and showed the 1D-band peak in the wavenumber range of 2,600 to 2,780 cm⁻¹, the 1G-band peak in the wavenumber range of 1,560 to 1,600 cm⁻¹, and the 2D-band peak in the wavenumber range of 2,680 to 2,725 cm⁻¹.

TABLE 2
Results of measurement at 532 nm
laser wavelength

| | Peak intensity | | |
|---|---|---|---|
| | 1G-band | 2D-band | I2D/IG |
| Example 1 | 24,584 | 11,791 | 0.47 |
| (before milling) | | | |
| Example 1 | 30,014 | 10,771 | 0.35 |
| (after milling) | | | |

TABLE 3
Results of measurement at 785 nm laser wavelength

| | Peak intensity | | |
|---|---|---|---|
| | 1D-band | 1G-band | ID/IG |
| Example 1 | 196 | 368 | 0.53 |
| (before milling) | | | |
| Example 1 | 109 | 333 | 0.33 |
| (after milling) | | | |

Referring to the results in Table 2 above, the Raman spectrum of the graphene (graphene layer) of Example 1, measured at a 532 nm laser wavelength, satisfied a ratio of ID-band peak intensity to 1G-band peak intensity (I_{1D}/I_{1G}) of 0.65 or less and a ratio of 2D-band peak intensity to 1G-band peak intensity (I_{2D}/I_{1G}) of 0.35 to 0.65, indicating that the graphene has excellent durability and electrical conductivity and a negative electrode active material including the graphene has high-capacity and high-output characteristics.

Referring to Table 3 above, it was found that, in the Raman spectrum of the graphene of Example 1, measured at a 785 nm laser wavelength, the ratio of 1D-band peak intensity to 1G-band peak intensity (ID/I_{G}) decreased from 0.53 before milling to 0.33 after milling.

(3) X-ray diffraction analysis: For analysis, the X-ray diffraction (XRD) spectra of the negative electrode active materials of Examples 1 and 3 and the graphene produced in Examples 1 and 3 were measured with a measurement device (Empyrean, Malvern Panalytical) using CuKα radiation of wavelength 1.54 Å.

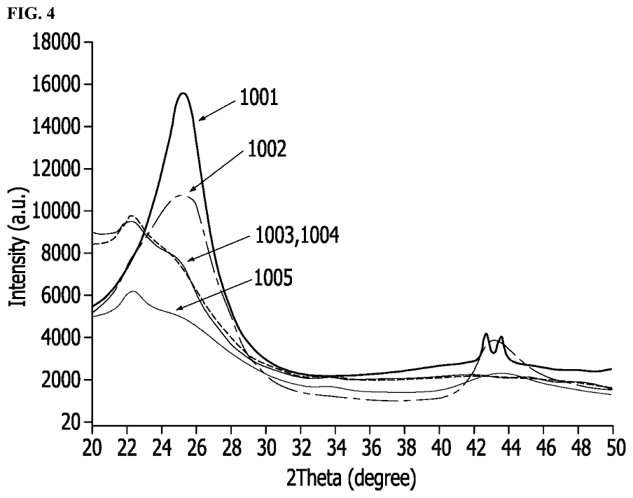

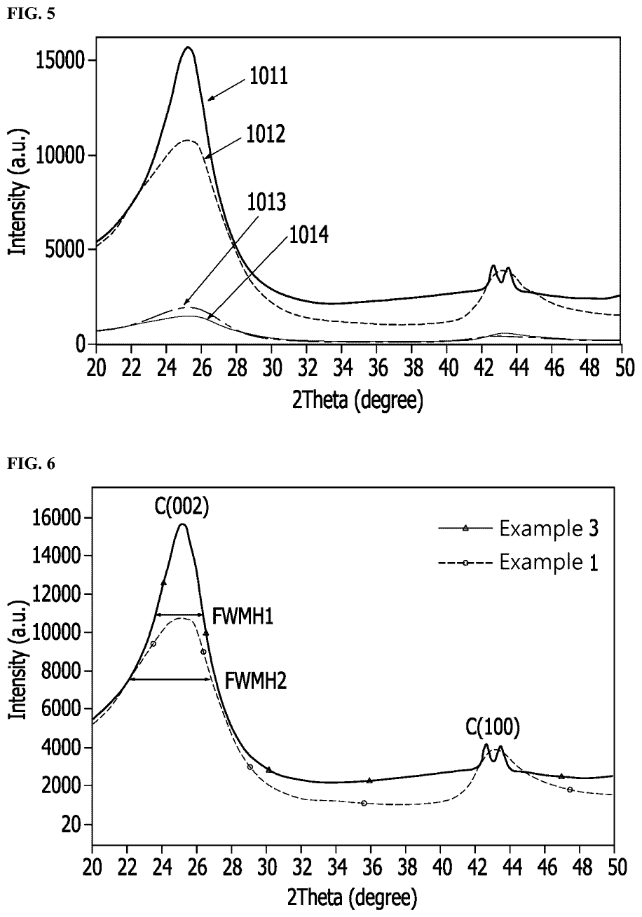

FIGS. 4 and 5 are graphs showing the X-ray diffraction (XRD) spectra of composite particles with different coating layers in the negative electrode active materials according to Examples 1 and 3.

The X-ray diffraction analysis was performed with an XRD instrument (Empyrean, Malvern Panalytical) using CuKα radiation of wavelength 1.54178 Å at a 2θ angle of 10 to 70° with a step size of 0.01°.

The curves (1001 and 1002) in FIG. 4 represent the negative electrode active materials of Examples 1 and 3, respectively. Specifically, 1001 represents the spectrum of Example 3 having a secondary particle structure including a second hollow core packed with a plurality of primary particles, and 1002 represents the spectrum of Example 1 having a first hollow core structure filled with composite particles.

Meanwhile, the curves (1003 and 1004) in FIG. 4 represent the spectra of negative electrode active materials having medium coating layer structures formed on the outer surfaces of composite particles using methane (CH₄) and acetylene (C₂H₂) gases, respectively. In addition, the curve 1005 in FIG. 4 represents the spectrum of a negative electrode active material having a soft coating layer structure formed on the outer surface of a composite particle using pitch.

Referring to FIG. 4, it could be seen that, when the medium coating layer (1003 or 1004) or the soft coating layer (1005) was formed on the outer surface of the composite particle, the peak intensity in the X-ray diffraction spectrum decreased compared to those of Example 1 (1002) and Example 3 (1001).

The curves (1011 and 1012) in FIG. 5 represent spectra when the hard coating layers according to Example 3 and Example 1 were applied, respectively.

In addition, the curves (1013 and 1014) in FIG. 5 represent the spectra of negative electrode active materials having medium coating layer structures formed on the outer surfaces of composite particles using methane (CH₄) and acetylene (C₂H₂) gases, respectively, and indicate that crystallinity decreased compared to those of Example 3 and Example 1.

Thereby, it could be seen that, when the first hollow core and second hollow core structures of Examples 1 and 3 were applied, they had high hardness and strength and excellent electrical conductivity.

In addition, for Example 1 (first hollow core) and Example 3 (second hollow core), the diffraction angle (20) value of the (002) plane was determined using the X-ray diffraction (XRD) spectrum measured with a measurement instrument (Empyrean, Malvern Panalytical) using CuKα radiation of wavelength 1.54 Å, and the results are shown in FIG. 6.

FIG. 6 shows X-ray diffraction (XRD) spectra of Examples 1 and 3. As shown in FIG. 6, in the X-ray diffraction spectra of the negative electrode active materials (first hollow core and second hollow core) of Examples 1 and 3, measured using CuKα radiation, the full width at half maximum for the diffraction peak of the (002) plane of the second hollow core (FWHM1) and the full width at half maximum for the diffraction peak of the (002) plane of the first hollow core (FWHM2) were measured to be 3.8° and 5.6°, respectively.

In addition, it could be seen that the peak intensity ratio value according to the following Equation 1, determined using the X-ray diffraction peak, was 2.9 to 3.4 for Example 1 and 4.8 to 5.4 for Example 3:

$$2 \leq I ( 002 ) / I ( 100 ) \leq 6 \qquad [ Equation 1 ]$$

wherein I(002) represents the peak intensity of the (002) plane of the first hollow core (or second hollow core), and I(100) represents the peak intensity of the (100) plane of the first hollow core (or second hollow core).

Meanwhile, it could be seen that, in the X-ray diffraction (XRD) spectra, the ratio of the peak intensity of the (002) plane to the peak intensity of the (101) plane was 80 to 150 for Example 1 and 80 to 200 for Example 3.

(4) Evaluation of charge/discharge characteristics (1): Fabrication of lithium secondary battery (1.0 Ah pouch-type full-cell): A pouch-type full-cell was fabricated using the negative electrode active material of each of Examples 1 to 3. Specifically, in Examples 1 to 3, negative electrode slurries containing a negative electrode active material with a capacity of about 364 mAh/g were prepared by mixing 97.1 wt % of the negative electrode active material produced in each of Examples 1 to 3 above, 1.65 wt % of carboxymethyl cellulose (CMC), and 1.25 wt % of styrene-butadiene rubber (SBR).

In Comparative Example 1, a negative electrode slurry was prepared by mixing 95.1 wt % of the negative electrode active material produced in Comparative Example 1 above, 1.65 wt % of carboxymethyl cellulose (CMC), 1.25 wt % of styrene-butadiene rubber (SBR), and 2 wt % of conductive materials (1 wt % of carbon black and 1 wt % of carbon nanotubes).

In addition, for Comparative Example 2, a negative electrode slurry was prepared by mixing 96.1 wt % of a negative electrode active material, 1.65 wt % of carboxymethyl cellulose (CMC), 1.25 wt % of styrene-butadiene rubber (SBR), and 1 wt % of a conductive material (carbon black).

Then, negative electrodes were fabricated by applying the slurry prepared in each of Examples 1 to 3 and Comparative Examples 1 and 2 onto a negative electrode current collector, followed by drying and pressing. The loading amount of the negative electrode slurry was 6.5±0.5 mg/cm², and the electrode density was 1.55 to 1.60 g/cc.

Then, pouch cells (full-cells) with a capacity of 1.0 Ah were fabricated according to a conventional method using each of the fabricated negative electrodes, a positive electrode (NCM811) as a counter electrode to the negative electrode, an electrolyte, and a separator (including polypropylene and polyethylene).

Here, the electrolyte used was prepared by dissolving 1 M LiPF₆ in a mixed solvent of ethyl methyl carbonate (EMC) and ethylene carbonate (EC) (EMC and EC=5:5 volume ratio).

The full-cells of Examples 1 to 3 and Comparative Examples 1 and 2 were aged at room temperature (25° C.) for 20 hours or more, and then subjected to electrochemical evaluation at room temperature.

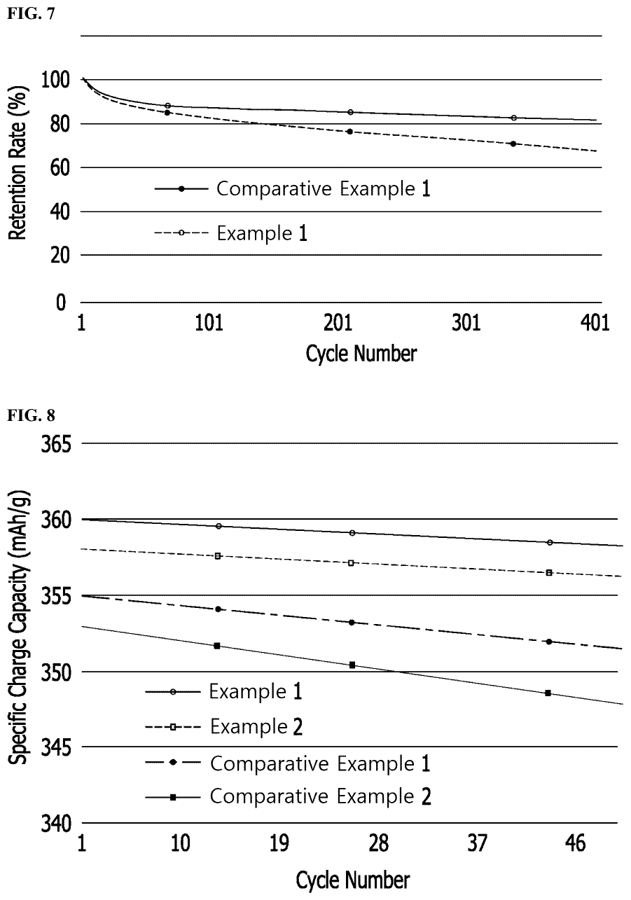

Specifically, the full-cells of the Examples and the Comparative Examples were subjected to one formation cycle at 0.1 C charge/0.1 C discharge in the operating voltage range of 2.75 V to 4.20 V. In the first cycle, the cells were charged at 0.1 C with a cut-off current of 0.005 C. Then, the second cycle was performed under the standard conditions of 0.2 C charge, 0.01 C cutoff and 0.1 C discharge. Next, during charging based on the 0.2 C discharge capacity of the second cycle, a charge current of 0.5 C with a cutoff current of 0.02 C was applied, and the 400-cycle capacity retention rate was measured under the conditions of 1.0 C/4.2V cutoff. The results are shown in Table 4 below and FIG. 7.

In addition, the initial discharge capacity (mAh/g), initial charge capacity (mAh/g), and initial coulombic efficiency (%) of the Examples and the Comparative Examples were evaluated, and the results are shown in Table 5 below.

TABLE 4

| | Charge/ | |
|---|---|---|
| | discharge | Capacity |
| | efficiency | retention |
| | (%) in first | rate @400 |
| | cycle | (%) |
| | (0.1 C/0.1 C) | cycle |
| Example 1 | 95.9 | 82.6 |
| Example 2 | 95.8 | 83.2 |
| Example 3 | 95.9 | 84.5 |
| Comparative | 93.8 | 68.4 |
| Example | | |
| 1 | | |
| Comparative | 93.6 | 67.6 |
| Example | | |
| 2 | | |

TABLE 5

| | Initial | Initial | Initial |
|---|---|---|---|
| | discharge | charge | coulombic |
| | capacity | capacity | efficiency |
| | (mAh/g) | (mAh/g) | (%) |
| Example 1 | 360 | 340 | 94.4 |
| Example 2 | 358 | 330 | 92.2 |
| Example 3 | 366 | 353 | 94.9 |
| Comparative | 355 | 315 | 88.7 |
| Example | | | |
| 1 | | | |
| Comparative | 353 | 300 | 85.0 |
| Example | | | |
| 2 | | | |

FIG. 7 shows the results of evaluating the cycle life characteristics of Example 1 and Comparative Example 1. Referring to the results in FIG. 7, Table 4 and Table 5, it could be confirmed that Examples 1 to 3 had better charge/discharge efficiency and long-term life characteristics than Comparative Examples 1 and 2, and that the negative electrode active materials of Examples 1 to 3 were better than Comparative Examples 1 and 2 in terms of initial efficiency.

(5) Evaluation of charge/discharge characteristics (2): Charge/discharge evaluation was performed on Examples 1 and 2 and Comparative Examples 1 and 2, among the Examples and the Comparative Examples. Specifically, CR2032 half-coin cells (half-cells) were fabricated according to a conventional method using the negative electrode of each of Examples 1 and 2 and Comparative Examples 1 and 2, a lithium metal positive electrode (300-μm thick, MTI) as a counter electrode to the negative electrode, an electrolyte, and a separator (including polypropylene and polyethylene). The half-cells of the Examples and the Comparative Examples were charged and discharged for 50 cycles at a current of 0.5 C, and then the specific charge capacity was measured during the charge process at a current of 0.5 C. The results of the measurement are shown in FIG. 8.

FIG. 8 shows the results of testing the specific charge capacity of Examples 1 and 2 and Comparative Examples 1 and 2. Referring to FIG. 8, it could be seen that Examples 1 and 2 were more effective in preventing the specific charge capacity from decreasing with the number of cycles than Comparative Examples 1 and 2, indicating that the negative electrode active materials of Examples 1 and 2 had better charge/discharge efficiency and long-life characteristics.

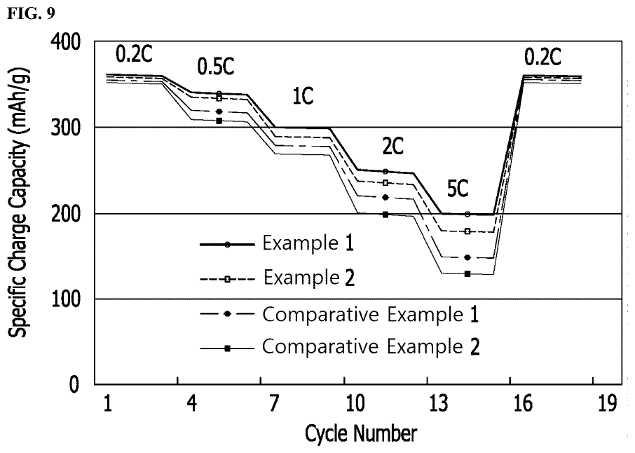

(6) Evaluation of charge/discharge characteristics (3): Charge/discharge evaluation (rate characteristic evaluation, rate capability evaluation) was performed on Examples 1 and 2 and Comparative Examples 1 and 2, among the Examples and the Comparative Examples. For Examples 1 and 2 and Comparative Examples 1 and 2, the charge cutoff voltage was set at 2.0 V, the charge current was set at 0.2 C, the discharge cutoff voltage was set at 0.05 V, but the discharge current value was changed from 0.2, 0.5, 1, 2, and 5 C. Under these conditions, the cells were charged and discharged for 20 cycles, and the results are shown in FIG. 9 below.

FIG. 9 shows the results of evaluating the rate characteristics of Examples 1 and 2 and Comparative Examples 1 and 2. Referring to FIG. 9, it could be seen that Examples 1 and 2 showed a lower decrease in the specific charge capacity with the change in C-rate than Comparative Examples 1 and 2, and thus had better rate characteristics.

So far, the present disclosure has been described with reference to the embodiments. Those of ordinary skill in the art to which the present disclosure pertains will appreciate that the present disclosure may be embodied in modified forms without departing from the essential characteristics of the present disclosure. Therefore, the disclosed embodiments should be considered from an illustrative point of view, not from a restrictive point of view. The scope of the present disclosure is defined by the claims rather than the foregoing description, and all differences within the scope equivalent thereto should be construed as being included in the present disclosure.

What is claimed is:

1. A negative electrode active material comprising:
a first hollow core having a first hollow portion formed therein; and
at least one composite particle packed in the first hollow portion,
wherein the composite particle comprises a graphite core, and a graphene layer and a first coating layer sequentially formed on an outer surface of the graphite core,
wherein the first coating layer comprises a hard coating layer, and the first coating layer and the first hollow core each have a higher hardness than the graphite core and the graphene layer.

2. The negative electrode active material according to claim 1, wherein the graphite core has an average size of 0.1 to 20 μm, the graphene layer has a thickness of 5 to 500 nm, and the first coating layer has a thickness of 300 nm to 1 μm.

3. The negative electrode active material according to claim 1, wherein the graphene layer comprises 1 to 10 layers, and a ratio of a peak intensity of a (002) plane to a peak intensity of a (101) plane in an X-ray diffraction (XRD) spectrum of the graphene layer is 50 or more.

4. The negative electrode active material according to claim 1, wherein a ratio of D-band peak intensity to G-band peak intensity (ID/I_{G}) in a Raman spectrum of the graphene layer is 0.65 or less.

5. The negative electrode active material according to claim 4, wherein the ratio of 2D-band peak intensity to G-band peak intensity (I_{2D}/I_{G}) in the Raman spectrum of the graphene layer is 0.35 to 0.65.

6. The negative electrode active material according to claim 1, wherein a Raman spectrum of the graphene layer shows a 2D-band peak in a wavenumber range of 2,660 to 2,720 cm⁻¹, a D-band peak in a wavenumber range of 1,320 to 1,370 cm⁻¹, and a G-band peak in a wavenumber range of 1,550 to 1,600 cm⁻¹.

7. The negative electrode active material according to claim 1, wherein the first hollow core has an inner diameter of 1.5 to 20 μm and a thickness of 5 to 1,000 nm.

8. The negative electrode active material according to claim 1, wherein the composite particle further comprises a second coating layer formed on an outer surface of the first coating layer, wherein the second coating layer comprises at least one of a soft coating layer, a medium coating layer, and a hard coating layer.

9. The negative electrode active material according to claim 8, wherein
the hard coating layer has a pencil hardness of 4H or higher as measured according to ISO 15184 and a density higher than 1.8 g/cm³,
the medium coating layer has a pencil hardness ranging from 2H to lower than 4H as measured according to ISO 15184 and a density ranging from higher than 1.5 g/cm³ to 1.8 g/cm³, and
the soft coating layer has a pencil hardness lower than 2H as measured according to ISO 15184 and a density of 1.5 g/cm³ or lower.

10. The negative electrode active material according to claim 1, wherein the first hollow core has a pencil hardness of 4H or higher as measured according to ISO 15184, an oxygen transmission rate of 4.0×10⁻² darcy or less, and a resistivity of 10 μΩ·m or less.

11. The negative electrode active material according to claim 1, wherein a full width at half maximum (FWHM) of X-ray diffraction angle (2θ) for a (002) plane of the first hollow core, measured using CuKα radiation, is 3° to 6°.

12. The negative electrode active material according to claim 1, wherein an X-ray diffraction peak of the first hollow core, measured using CuKα radiation, satisfies the following Equation 1:
$$2 \leq I ( 002 ) / I ( 100 ) \leq 6 \qquad [ Equation 1 ]$$
wherein I(002) represents a peak intensity of a (002) plane of the first hollow core, and I(100) represents a peak intensity of a (100) plane of the first hollow core.

13. The negative electrode active material according to claim 1, wherein the composite particle comprises 30 to 85 wt % of the graphite core, 0.1 to 30 wt % of the graphene layer, and 1 to 50 wt % of the first coating layer.

14. The negative electrode active material according to claim 1, further comprising a conductive component dispersed in the first hollow portion, wherein the conductive component comprises at least one of graphite particles, graphene, and conductive hard coating particles.

15. A negative electrode active material comprising:
a primary particle comprising a first hollow core having a first hollow portion formed therein and at least one composite particle packed in the first hollow portion; and
a secondary particle comprising a second hollow core having a second hollow portion formed therein and at least one primary particle packed in the second hollow portion,
wherein the composite particle comprises a graphite core, and a graphene layer and a first coating layer sequentially formed on an outer surface of the graphite core,
wherein the first coating layer comprises a hard coating layer, and the first coating layer, the first hollow core, and the second hollow core each have a higher hardness than the graphite core and the graphene layer.

16. A method for producing a negative electrode active material, comprising steps of:
producing composite particles;
producing dry powder by drying a mixed slurry comprising the composite particles and a solvent; and
producing a first intermediate using the dry powder and a hard coating material,
wherein the first intermediate comprises a first hollow core having a first hollow portion formed therein and at least one composite particle packed in the first hollow portion,
wherein the composite particle comprises a graphite core, and a graphene layer and a first coating layer sequentially formed on an outer surface of the graphite core,
wherein the first coating layer comprises a hard coating layer, and the first coating layer and the first hollow core each have a higher hardness than the graphite core and the graphene layer.

17. The method according to claim 16, wherein the step of producing composite particles comprises steps of:
preparing a first composition comprising graphite powder, graphene, and a hard coating material;
placing the first composition in a chamber, raising a temperature inside the chamber to 500 to 1,100° C., and reducing a pressure inside the chamber to below atmospheric pressure;
introducing a hydrocarbon gas and a buffer gas into the reduced-pressure chamber to contact the first composition; and
performing heat treatment by gradually increasing the pressure inside the chamber while maintaining the raised temperature.

18. The method according to claim 17, wherein the graphene is formed by milling the graphite powder.

19. A method for producing a negative electrode active material, comprising steps of:
producing composite particles;
producing dry powder by drying a mixed slurry comprising the composite particles and a solvent; and
producing a second intermediate using the dry powder and a hard coating material,
wherein the second intermediate comprises a primary particle comprising a first hollow core having a first hollow portion formed therein and at least one composite particle packed in the first hollow portion, and a secondary particle comprising a second hollow core having a second hollow portion formed therein and at least one primary particle packed in the second hollow portion,
wherein the composite particle comprises a graphite core, and a graphene layer and a first coating layer sequentially formed on an outer surface of the graphite core,
wherein the first coating layer comprises a hard coating layer, and the first coating layer, the first hollow core, and the second hollow core each have a higher hardness than the graphite core and the graphene layer.

20. A secondary battery comprising:
a positive electrode;
a negative electrode; and
an electrolyte formed between the positive electrode and the negative electrode,
wherein the negative electrode comprises the negative electrode active material according to claim 1.
